(19) United States
(12) Patent Application Publication
(10) Pub. No.: US 2006/0251247 A1
(43) Pub. Date: Nov. 9, 2006

(54) Encryption apparatus, decryption apparatus, key generation apparatus, program and method therefor

(76) Inventors: Koichiro Akiyama, Tokyo (JP); Yasuhiro Goto, Hakodate-shi (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(21) Appl. No.: 11/220,641

(22) Filed: Sep. 8, 2005

(30) Foreign Application Priority Data
Jan. 11, 2005 (JP) 2005-004220

(51) Int. Cl. H04L 9/28; H04L 9/30; H04L 9/00; H04K 1/00

(52) U.S. Cl. 380/28; 380/30; 380/44

(57) ABSTRACT

According to one aspect of the present invention, a public-key encryption method which can assure security even though a quantum computer appears, which can be securely realized by an existing computer, and which may be realized in a low-electric-power environment can be constituted. More specifically, one spect of the present invention uses an integer solution of a diophantine equation as a private key. In this manner, an encryption apparatus, a decryption apparatus, or a key generation apparatus of a public-key encryption method using a problem that calculates an integer solution of a diophantine equation having no general solution algorithm as the basis of security is realized. Therefore the above problem can be solved.

### CROSS-REFERENCE TO RELATED APPLICATIONS

This application is based upon and claims the benefit of priority from prior Japanese Patent Application No. 2005-004220, filed Jan. 11, 2005, the entire contents of which are incorporated herein by reference.

### BACKGROUND OF THE INVENTION

1. Field of the Invention

The present invention relates to an encryption apparatus, a decryption apparatus, a key generation apparatus, and a program and a method therefor by using a diophantine equation.

2. Description of the Related Art

In the networked society, a large number of information such as electronic mail is transmitted over networks to perform communication between people. In the networked society, cryptographic technology is popularly used as a means for maintaining security and authenticity of information.

Cryptographic technology can be classified into symmetric-key cryptographic technology and public-key cryptographic technology. The symmetric-key cryptosystem is an encryption method based on a data shuffle algorithm, and can perform encryption/decryption at high speed. However, according to the symmetric-key cryptography, secure communication or authenticated communication can be achieved only between two people who share a symmetric key in advance.

For this reason, the symmetric-key cryptosystem is mainly used for encryption of information to be decrypted on real time after reception as in pay digital broadcast. In this case, a decryption key for the pay digital broadcast is delivered only to subscribers by separately using a key delivery system called a limited receiving system.

On the other hand, a public-key cryptosystem is an encryption method based on a mathematical algorithm, and performs encryption/decryption at a speed lower than that of the symmetric-key cryptosystem. However, the public-key cryptosystem can advantageously perform secure communication and authenticated communication without advance key sharing. More specifically, the public-key cryptosystem realizes secure communication by performing an encryption process using a public key of the destination and makes it possible to perform authenticated communication by means of a digital signature using a private key of the source.

In the case of an Internet shopping mall, bank, or brokerage, the public-key cryptosystem is often used to protect customer information such as credit card numbers and addresses from interception. This is because an encryption key to encrypt customer information cannot always be shared, so the symmetric-key cryptosystem is not suitable for the above on-line sites.

As typical public-key cryptosystems, an RSA cryptosystem and an elliptic curve cryptosystem are known. The RSA cryptosystem uses the difficulty of prime factorization as the basis of security and uses a power remainder operation as an encrypting operation. The elliptic curve cryptosystem uses a discrete logarithm problem on an elliptic curve as the basis of security, and a point operation on an elliptic curve is used as an encrypting operation.

In these public-key cryptosystems, a decryption method related to a specific key (public key) is proposed, but a general decryption method is not known. For this reason, an important problem related to security has not been detected until now except for a decryption method by a quantum computer (to be described later).

As other public-key cryptosystems, a knapsack cryptosystem, a multi-order multivariable cryptosystem, and the like are known. The knapsac cryptosystem uses the difficulty of a knapsac problem serving as an NP problem as the basis of security. The multi-order multivariable cryptosystem is an encryption system which is arranged by using the extended theory of a field and uses a problem that calculates a solution of simultaneous solutions as the basis of security.

However, since the decipher method of the knapsac cryptosystem is known in almost all realizing forms, a problem in security is posed. In the multi-order multivariable cryptosystem, a dominant decipher is known. On the other hand, it is known that the decipher method can be avoided by an increase in key size. However, multi-order multivariable cryptosystem requires a huge key size to avoid the decipher method, and this has become a problem.

On the other hand, the RSA cipher and the elliptic curve cipher are probably decoded by the appearance of a quantum computer. The quantum computer, unlike an existing computer, can execute a massively parallel calculation by using a physical phenomenon called entanglement in the quantum theory. The quantum computer is an experimental, virtual computer, and is being developed for practical use. In 1994, Shor showed that an algorithm which can efficiently solve prime factorization or discrete logarithm can be constituted by a quantum computer. More specifically, when the quantum computer is realized, the RSA cipher based on prime factorization or an elliptic curve cipher based on discrete logarithm problem on an elliptic curve may be probably decoded.

On the other hand, in a public-key cryptosystem the security can be maintained even if a quantum computer is realized has been studied. A quantum public-key cryptosystem (for example, see T. Okamoto and K. Tanaka and S. Uchiyama: “Quantum Public-Key Cryptosystems”, Advances in Cryptology—CRYPTO 2000, Lecture Notes in Computer Science, vol. 1880, pp. 147 to 165, Springer-Verlag, 2000.) is an example of such cryptosystem. In the quantum public-key cryptosystem, a key of a knapsac cryptosystem which is strong enough to make it impossible to generate a key by an existing computer is generated. In the quantum public-key cryptosystem, a knapsac cipher which is strong enough not to be decoded by a quantum computer can be constituted. However, in the quantum public-key cryptosystem, a key cannot be generated by an existing computer. For this reason, the quantum public-key cryptosystem cannot be used at the present.

On the other hand, the multi-order multivariable cryptosystem is a public-key cryptosystem which can be realized at the present, a multi-order multivariable cipher cannot be easily decoded even by a quantum computer. However, since the multi-order multivariable cryptosystem has a secure key size which is huge for an existing computer, the practical use of the multi-order multivariable cryptosystem is called into question.

In addition, the public-key cryptosystem requires a circuit scale larger than that of the symmetric-key cryptosystem and a processing time longer than that of the symmetric-key cryptosystem. Therefore, the public-key cryptosystem cannot be realized by a low-electric-power environment such as a mobile terminal, or if the public-key cryptosystem can be realized, waiting time is disadvantageously long. For this reason, a public-key cryptosystem which can be realized by a low-electric-power environment is demanded.

In general, a public-key cipher is designed such that a problem such as a prime factorization problem or a discrete logarithm problem which cannot be easily calculated is found out and a ciphertext is tried to be decoded without knowing a private key by the same manner as that used when the problem which cannot be easily calculated is solved.

However, even though the problem which cannot be easily calculated can be found out, a public-key cipher using the problem as the basis of security cannot be easily constituted. This is because, when the cipher includes a problem which is excessively difficult to be calculated as the basis of security, a problem that generates a key is also difficult, and the key cannot be generated. On the other hand, when the problem is made easy enough to make it possible to generate a key, the cipher can be easily decoded.

Therefore, to constitute the public-key cipher, a problem which cannot be easily calculated is found out, and the found problem is remade into a problem having a skilled balance in which a key can be easily generated but decipher cannot be easily achieved. The remaking of the problem requires high creativity. In fact, since it is very difficult to remake a problem, only several public-key cryptosystems are proposed.

As described above, in the public-key encryption method, it is desired to make it difficult to perform decipher by a quantum computer and to be realized by an existing computer. Furthermore, the public-key encryption method is also desired to be realized by a low-electric-power environment.

### BRIEF SUMMARY OF THE INVENTION

It is an object of the present invention to provide an encryption apparatus, a decryption apparatus, a key generation apparatus, and a program and a method therefor which can constitute a public-key encryption method which can assure security even in the appearance of a quantum computer, which can be securely realized by an existing computer, and which may be able to be realized in a low-electric-power environment.

According to a first aspect of the present invention, there is provided an encryption apparatus to encrypt a message on the basis of a diophantine equation X(x₁, . . . , xₙ) serving as a public key and a minimum degree L of an irreducible polynomial when a private key for decryption is two integer solutions corresponding to a diophantine equation X(x₁, . . . , xₙ)=0, the encryption apparatus comprising: a developing device configured to develop the message into an integer m; an embedding device configured to embed the integer m in a polynomial m(t) having a degree not more than a degree (L−1); a polynomial generating device configured to generate two random polynomials p(x₁, . . . , xₙ, t) and q₁(x₁, . . . , xₙ, t); an irreducible polynomial generating device configured to generate a random irreducible polynomial f(t) having a degree not less than a degree L; and an arithmetic operation performing device configured to perform an arithmetic operation including at least one of addition, subtraction, and multiplication of the polynomials p(x₁, . . . , xₙ, t) and q(x₁, . . . , xₙ, t), the irreducible polynomial f(t), and the diophantine equation X(x₁, . . . , xₙ) serving as a public key to the polynomial m(t) to generate a ciphertext F=Eₚₖ(m,p,q,f,X) from the polynomial m(t).

According to a second aspect of the present invention, there is provided an encryption apparatus to encrypt a message on the basis of a diophantine equation X(x₁, . . . , xₙ) serving as a public key and a minimum degree L of an irreducible polynomial when a private key for decryption is one integer solution corresponding to a diophantine equation X(x₁, . . . , xₙ)=0, the encryption apparatus comprising: a developing device configured to develop the message into an integer m; an embedding device configured to embed the integer m in a polynomial m(t) having a degree not more than a degree (L−1); a polynomial generating device configured to generate two random combinations of polynomials p₁(x₁, . . . , xₙ, t), p₂(x₁, . . . , xₙ, t), q₁(x₁, . . . , xₙ, t), and q₂(x₁, . . . , xₙ, t) at least one of which is different from the other polynomial; an irreducible polynomial generating device configured to generate a random irreducible polynomial having a degree not less than a degree L; and an arithmetic operation performing device configured to perform an arithmetic operation including at least one of addition, subtraction, and multiplication of the polynomials p₁(x₁, . . . , xₙ, t), p₂(x₁, . . . , xₙ, t), q₁(x₁, . . . , xₙ, t), and q₂(x₁, . . . , xₙ, t), the irreducible polynomial f(t), and the diophantine equation X(x₁, . . . , xₙ) serving as a public key to the polynomial m(t) to generate ciphertexts F₁=Eₚₖ(m,p₁,q₁,f,X) and F₂=Eₚₖ(m,p₂,q₂,f,X) from the polynomial m(t).

According to a third aspect of the present invention, there is provided a decryption apparatus to decrypt a message from a ciphertext F=Eₚₖ(m,p,q,f,X) on the basis of two integer solutions S₁ and S₂ corresponding to a diophantine equation X(X₁, xₙ)=0 and serving as private keys for decryption stored in advance when the ciphertext F=Eₚₖ(m,p,q,f,X) is input, the ciphertext F=Eₚₖ(m,p,q,f,X) being generated from a polynomial m(t) having a degree not more than a degree (L−1) and obtained by embedding a message such that an arithmetic operation including at least one of addition, subtraction, and multiplication of two random polynomials p(x₁, . . . , xₙ, t) and q(x₁, . . . , xₙ, t), an irreducible polynomial f(t), and a diophantine equation X(x₁, . . . , xₙ) serving as a public key is performed to the polynomial m(t), the decryption apparatus comprising: an integer solution assigning device configured to separately assign the integer solutions S₁ and S₂ to the input ciphertext F to generate two polynomials h₁(t) and h₂(t); a polynomial subtracting device configured to subtract the other polynomial h₂(t) from one polynomial h₁(t) obtained by the assignment to obtain a subtraction result (h₁(t)−h₂(t)); a factorizing device configured to factorize the subtraction result (h₁(t)−h₂(t)); an irreducible polynomial extracting device configured to extract an irreducible polynomial f(t) having the maximum degree from the factorization result; and a dividing device configured to divide the polynomial h₁(t) or h₂(t) obtained by the assignment by the irreducible polynomial f(t) to acquire a remainder equivalent to the polynomial m(t) corresponding to the message.

According to a fourth aspect of the present invention, there is provided a decryption apparatus to decrypt a message from ciphertexts F₁=Eₚₖ(m,p₁,q₁,f,X) and F₂=Eₚₖ(m,p₂,q₂,f,X) on the basis of one integer solution S corresponding to a diophantine equation X(X₁, . . . , xₙ)=0 and serving as a private key for decryption stored in advance when the ciphertexts F₁=Eₚₖ(m,p₁,q₁,f,X) and F₂=Eₚₖ(m,p₂,q₂,f,X) are input, the ciphertexts F₁=Eₚₖ(m,p₁,q₁,f,X) and F₂=Eₚₖ(m,p₂,q₂,f,x) being generated from a polynomial m(t) having a degree not more than a degree (L−1) and obtained by embedding a message such that an arithmetic operation including at least one of addition, subtraction, and multiplication of two random combinations of polynomials p₁(x₁, xₙ, t), p₂(x₁, . . . , xₙ, t), q₁(x₁, . . . , xₙ, t), and q₂(x₁, . . . , xₙ, t) at least one of which is different from the other polynomial, an irreducible polynomial f(t), and a diophantine equation X(x₁, . . . , xₙ) serving as a public key is performed to the polynomial m(t), the decryption apparatus comprising: an integer solution assigning device configured to separately assign the integer solution S to the input ciphertexts F₁ and F₂ to generate two polynomials h₁(t) and h₂(t); a polynomial subtracting device configured to subtract the other polynomial h₂(t) from one polynomial h₁(t) obtained by the assignment to obtain a subtraction result (h₁(t)−h₂(t)); a factorizing device configured to factorize the subtraction result (h₁(t)−h₂(t)); an irreducible polynomial extracting device configured to extract an irreducible polynomial f(t) having the maximum degree from the factorization result; and a dividing device configured to divide the polynomial h₁(t) or h₂(t) obtained by the assignment by the irreducible polynomial f(t) to acquire a remainder equivalent to the polynomial m(t) corresponding to the message.

According to a fifth aspect of the present invention, there is provided a key generation apparatus to generate a diophantine equation X(X₁, . . . , xₙ) serving as a public key to decrypt a polynomial m(t) having a degree not more than a degree (L−1) and obtained by embedding a message and two integer solutions S₁ and S₂ corresponding to the diophantine equation X(X₁, . . . , xₙ)=0 and serving as a private key to decrypt the decrypted polynomial m(t), the key generation apparatus comprising: a diophantine equation determining device configured to determine a diophantine equation having a form in which a plurality of coefficients are set as variables; an integer solution generating device configured to generate two integer solutions S₁=(c₁, . . . , cₙ) and S₂=(g₁, . . . , gₙ) at random; a matrix expressing device configured to express, as a matrix, simultaneous equations obtained by assigning the two integer solutions S₁ and S₂ to the diophantine equation having the form to generate a coefficient matrix of the simultaneous equations; a flushing method performing device configured to perform a flushing method to the coefficient matrix to arithmetically operate an elementary solution where some coefficients of the coefficients are expressed by other coefficients which are free variables; a random value assigning device configured to assign random values to the free variables of the elementary solution to generate a first coefficient vector where coefficients are expressed by integer elements and/or rational elements; a multiplying device configured to multiply the elements of the first coefficient vectors by the least common multiple of the denominators of the elements to generate a second coefficient vector where the coefficients are expressed by integer elements; and a diophantine equation generating device configured to generate the diophantine equation X on the basis of the second coefficient vector and the diophantine equation having the form.

According to a sixth aspect of the present invention, there is provided a key generation apparatus to generate a diophantine equation X(X₁, . . . , xₙ) serving as a public key to decrypt a polynomial m(t) having a degree not more than a degree (L−1) and obtained by embedding a message and an integer solution S corresponding to the diophantine equation X(X₁, . . . , xₙ)=0 and serving as a private key to decrypt the decrypted polynomial m(t), the key generation apparatus comprising:

a diophantine equation determining device configured to determine a diophantine equation having a form consisting of a variable term having coefficients as variables and a constant term;

an integer solution generating device configured to generate an integer solution S at random;

a coefficient determining device configured to determine the coefficients of the variable term in the diophantine equation having the form at random; and

a constant term calculating device configured to calculate the constant term of the diophantine equation having the form from the generated integer solution S and the determined coefficient to generate the diophantine equation X.

In the first to sixth aspects of the present invention, an encryption apparatus, a decryption apparatus, or a key generation apparatus using a public-key encryption method having a problem that calculates an integer solution of a diophantine equation for which a general solution algorithm does not exist as the basis of the security is realized by a configuration using an integer solution of a diophantine equation X as a private key. For this reason, a public-key encryption method which can assure the security even if a quantum computer appears, which can be securely realized by an existing computer, and which can be realized in a low-electric-power environment can be configured.

### BRIEF DESCRIPTION OF THE SEVERAL VIEWS OF THE DRAWING

FIG. 1 is a diagram of an entire configuration of a key generation apparatus according to the first embodiment of the present invention;

FIG. 2 is a flowchart for explaining a flow of processes in the key generation apparatus according to the embodiment;

FIG. 3 is a diagram of an entire configuration of an encryption apparatus according to the embodiment;

FIG. 4 is a flowchart for explaining a flow of processes in the encryption apparatus according to the embodiment;

FIG. 5 is a diagram of an entire configuration of a decryption apparatus according to the embodiment;

FIG. 6 is a flowchart for explaining a flow of processes in the decryption apparatus according to the embodiment;

FIG. 7 is a flowchart for explaining a flow of processes in a first variation of the key generation apparatus according to the embodiment;

FIG. 8 is a flowchart for explaining a flow of processes in a key generation apparatus according to the second embodiment of the present invention;

FIG. 9 is a flowchart for explaining a flow of processes in the encryption apparatus according to the embodiment;

FIG. 10 is a flowchart for explaining a flow of processes in a decryption apparatus according to the embodiment;

FIG. 11 is a flowchart for explaining a flow of processes in a third variation of the decryption apparatus according to the embodiment; and

FIG. 12 is a diagram of an entire configuration of a key generation apparatus according to the embodiment.

### DETAILED DESCRIPTION OF THE INVENTION

Embodiments of the present invention will be described below with reference to the accompanying drawings.

### FIRST EMBODIMENT

To calculate an integer solution common in a finite number of equations having integers as coefficients is to solve diophantine equations or indefinite equations. Equations with integer coefficients (infinite number) set on the assumption that integer solutions are calculated are called diophantine equations or indefinite equations. For example, equations (1) which are simultaneous equations including integer coefficients are diophantine equations.

$$\{ \begin{matrix}{x}^{3} + 2 {y}^{3} - 5 {z}^{4} = 0 \\ 35 {x}^{3} - 8 {y}^{3} + 23 {z}^{4} = 0\end{matrix} \\ \qquad ( 1 )$$

A problem that calculates an integer solution of a diophantine equation has been studied since pre-Christian times and has attracted attention among many mathematicians. The problem is a base for establishing one field, i.e., the theory of numbers.

In recent years, it has been understood that there is no solution algorithm for a problem that calculates an integer solution of a diophantine equation. More specifically, in order to solve the diophantine equation (or equation groups), only a method of applying a unique solution algorithm to the equation must be used. However, diophantine equations (or diophantine equation groups) the solution algorithms of which are known are extremely limited.

A problem that calculates the integer solution of the diophantine equation can be considered a considerably difficult problem when a general solution algorithm for a prime factorization problem used as the basis of security in the RSA cryptosystem or a discrete logarithm problem on an elliptic curve used as the basis of security in the elliptic curve cryptosystem is known. In fact, it is known that a problem that calculates an integer solution of a quadratic diophantine equation is an NP-complete problem (except for some actual examples).

In the embodiment, for descriptive convenience, only a diophantine equation constituted by one equation and having n variables is handled, the diophantine equation is described as X(x₁, . . . , Xₙ)=0.

However, the essential part of the present invention is to constitute a public-key cryptosystem which uses a problem that calculates an integer solution of a diophantine equation as the basis of security. For this reason, a configuration which uses a plurality of diophantine equations within the scope of the invention can be effected.

A concrete configuration of a public-key cryptosystem based on the difficulty of a problem that calculates an integer solution of a diophantine equation will be described below.

A public key according to the fist embodiment is the following diophantine equation X.
diophantine equation X (x₁, . . . , xₙ)=0

Secret keys are the following two solutions:

1. Integer solution of diophantine equation X: S₁: (x1, . . . ,xₙ)=(c₁, . . . , cₙ)

2. Integer solution of diophantine equation X: S₂: (x1, . . . ,xₙ)=(g₁, . . . , gₙ)

These solutions can be easily calculated by a method (key generation method) (to be described later).

An outline of an encrypting process will be described below. In the encrypting process, a message (to be referred to as a plaintext hereinafter) to be encrypted is converted into an integer m, and the integer m is assigned to coefficients of a polynomial having a degree of (L−1) or less. In this case, the symbol L denotes the minimum degree of an irreducible polynomial f(t) determined between a receiver and a transmitter in the encryption of the message. A polynomial q(x₁, . . . , xₙ, t) having integer coefficients is generated at random. Subsequently, a polynomial p(x₁, . . . , xₙ, t) having a constant term and integer coefficients is generated at random within the range in which a condition (2), a condition (3) and a condition (4) are satisfied. The condition (2) is as follows.
1≦∀i≦ndegₓᵢp(x₁, . . . ,xₙ,t)>degₓᵢX(x₁, . . . ,xₙ) (2)

degₓᵢp(x₁, . . . , xₙ, t) expresses a degree when the polynomial p(x₁, . . . , xₙ, t) is considered a polynomial of a variable xᵢ. For example, a degree degₓ of x and a degree deg_{y} of y are given as follows:
degₓ(x³y⁴+2x²y⁵t+5xyt²+3)=3,
deg_{y}(x³y⁴+2x²y⁵t+5xyt²+3)=5

The condition (3) is as follows:
∀cx₁^{αis 1}x₂^{α}^{₂} . . . xₙ^{α}^{ₙ}εX(x₁, . . . ,xₙ)∃dx₁^{β}^{₁}x₂^{β}^{₂} . . . xₙ^{β}^{ₙ}εp(x₁, . . . ,xₙ)1≦∀ᵢ≦nαᵢ<βᵢ (3)

where cx₁^{α}^{₁}x₂^{α}^{₂} . . . xₙ^{α}^{ₙ}εX(x₁, . . . ,xₙ) means that the term cx₁^{α}^{₁}x₂^{α}^{₂} . . . xₙ^{α}^{ₙ} is included in the polynomial X(x₁, . . . , xₙ), and c and d are constants and integers. Therefore, the condition (3) means that, with respect to any term dx₁^{β}^{₁}x₂^{β2} . . . xₙ^{β}^{ₙ} of X(x₁, . . . , xₙ), a term of the polynomial p(x₁, . . . , xₙ) having a degree βᵢ equal to or higher than a degree αᵢ of an arbitrary variable xᵢ of the polynomial X(x₁, . . . , xₙ) exists. Furthermore, a condition (4) is as follows:
max{degₜp(x,y,t),degₜq(x,y,t)}<Lmax{degₜp(x₁, . . . ,xₙ,t),degₜq(x₁, . . . ,xₙ,t)}<L (4)

A random irreducible polynomial f(t) is generated. In this case, an extremely efficient algorithm exists to an irreducible polynomial generating process. The irreducible polynomial generating process includes a process of selecting a polynomial at random and an irreducibility determining process of determining whether the selected polynomial is an irreducible polynomial or not. In the irreducible polynomial generating process, the above processes are repeated until a polynomial determined as an irreducible polynomial is obtained. For this reason, the irreducible polynomial generating process can be performed within a relatively short period.

When the irreducible polynomial f(t) is obtained, a ciphertext F(x₁, . . . , xₙ, t) is calculated using the following equation (5).
F(x₁, . . . ,xₙ,t)=m(t)+f(t)p(x₁, . . . , xₙ,t)+X(x₁, . . . ,xₙ)q(x₁, . . . ,xₙ,t) (5)

As will be described in the following <Study of Security>, only one of the random polynomials p(x₁, . . . , xₙ, t) and q(x₁, . . . , xₙ, t) is absent, a problem in security is posed. More specifically, the two random polynomials p(x₁, . . . , xₙ, t) and q(x₁, . . . , xₙ, t) are inevitably included in the equation (5) from a viewpoint of security.

A receiver who receives the ciphertext F(x₁, . . . , xₙ, t) performs decryption by using her/his own private keys S₁ and S₂ as follows. Integer solutions S₁ and S₂ are assigned to the ciphertext F(x₁, . . . , xₙ, t).

As a result of the assignment, X(c₁, . . . , cₙ)=0 and X(g₁, . . . , gₙ)=0 are satisfied. For this reason, the following two polynomials h₁(t) and h₂(t) are calculated.
h₁(t)=F(c₁, . . . ,c_{n,t})=m(t)+f(t)p(c₁, . . . , cₙ,t)
h₂(t)=F(g₁, . . . ,gₙ,t)=m(t)+f(t)ₚ(g₁, . . . , gₙ,t)

The sides of the two equations are subtracted from each other, respectively to calculate the following equation (6):
h₁(t)−h₂(t)=f(t){p(c₁, . . . ,cₙ,t)−p(g₁, . . . , gₙ,t)} (6)

The side: h₁(t)−h₂(t) obtained by the calculate is factorized to define an irreducible polynomial having the maximum degree as f(t). In this case, according to the condition (4), the degree of a factor {p(c₁, . . . , cₙ, t)−p(g₁, . . . , gₙ, t)} is suppressed to (L−1), so that f(t) can be determined as an irreducible polynomial having the maximum degree. When the degree of h₁(t)−h₂(t) is an integer of about 50, an algorithm which can be executed for actual time is known for factorization of h₁(t)−h₂(t). When the integer h₁(t) is divided by the irreducible polynomial f(t) (take notice that the order of m(t) is smaller than the degree of f(t)), a polynomial m(t) obtained by embedding a plaintext as a remainder can be uniquely acquired from the relationship of the following equation:
h₁(t)=m(t)+f(t)ₚ(c₁, . . . ,cₙ,t)

Finally, a key generation method in the embodiment will be described below. The key generating is performed as follows. That is, integer solutions S₁ and S₂ are selected at random, and a diophantine equation corresponding to the integer solutions S₁ and S₂ is generated. In order to cause the generated diophantine equation to simultaneously have the integer solutions S₁ and S₂, the following devising is performed.

A form of a diophantine equation is determined first. As an example, the shape of equation (7) is employed.
X(x,y)=a₁x²y³+a₂y²+a₃x+a₄=0 (7)

In this case, for descriptive convenience, a diophantine equation having two variables defined as x₁=x and x₂=y are considered. Reference symbols a₁, . . . , a₄ denote coefficients and integers. When a diophantine equation is used as a public key for a public-key cryptosystem, it is desired that the equation includes a constant term. This is because, when the equation does not include a constant term, a trivial solution (0, . . . , 0) exists, a heavy hint for decryption is given.

An integer solution S1: (c₁, . . . , cₙ) and an integer solution S2: (g₁, . . . , gₙ) are selected at random. In a key generation method described in the embodiment, integer solutions are determined at random in advance, and the integer solutions are adjusted by the coefficients of the diophantine equation. For this reason, the integer solutions are not conditioned at all.

Randomly generated integer solutions S1=(c₁, c₂) and S2=(g₁, g₂) are assigned to a diophantine equation X(x,y) to obtain the following equations:
a₁c₁^{2c}₂³+a₂c₂²+a₃c₁+a₄=0
a₁g₁²g₂³+a₂g₂²+a₃g₁+a₄=0
These equations are further transformed into:

$$( \begin{matrix}{c}_{1}^{2} & {c}_{2}^{3} & {c}_{2}^{2} & {c}_{1} & 1 \\ {g}_{1}^{2} & {g}_{2}^{3} & {g}_{2}^{2} & {g}_{1} & 1\end{matrix} ) ( \begin{matrix}{a}_{1} \\ {a}_{2} \\ {a}_{3} \\ {a}_{4}\end{matrix} ) = ( \begin{matrix}0 \\ 0 \\ 0 \\ 0\end{matrix} )$$

and a flushing method is applied to a coefficient matrix:

$$( \begin{matrix}{c}_{1}^{2} & {c}_{2}^{3} & {c}_{2}^{2} & {c}_{1} & 1 \\ {g}_{1}^{2} & {g}_{2}^{3} & {g}_{2}^{2} & {g}_{1} & 1\end{matrix} )$$

to obtain the following relational expression:

$$( \begin{matrix}{u}_{1} & {u}_{2} & 1 & 0 \\ {v}_{1} & {v}_{2} & 0 & 1\end{matrix} ) ( \begin{matrix}{a}_{1} \\ {a}_{2} \\ {a}_{3} \\ {a}_{4}\end{matrix} ) = ( \begin{matrix}0 \\ 0 \\ 0 \\ 0\end{matrix} )$$

where u₃, u₄, v₃, and v₄ are rational numbers in general. From the relational expression, the following elementary solutions are obtained:
a₃=−u₁a₁−u₂a₂
a₄=−v₁a₁−v₂a₂.
Random integers (or rational numbers) are assigned to free variables a₁ and a₂ in the elementary solutions to calculate a₃ and a₄ as rational numbers. In addition, the numbers a₁, a₂, a₃, and a₄ are multiplied by the least common multiple of denominators to make it possible to calculate coefficients a₁, a₂, a₃, and a₄ as integers. In this manner, a diophantine equation having two random integer solutions S₁ and S₂ can be generated. When the coefficient matrix is transformed by the flushing method into:

$$( \begin{matrix}{u}_{1}^{′} & {u}_{2}^{′} & 0 & 1 \\ {v}_{1}^{′} & {v}_{2}^{′} & 1 & 0\end{matrix} ) ( \begin{matrix}{a}_{1} \\ {a}_{2} \\ {a}_{3} \\ {a}_{4}\end{matrix} ) = ( \begin{matrix}0 \\ 0 \\ 0 \\ 0\end{matrix} )$$

coefficients a₁, a₂, a₃, and a₄ can be calculated by the same algorithm as described above.

The key generation method, as is apparent from the configuration thereof, can be achieved by not only the diophantine equation having the form expressed by the equation (7) but also a general diophantine equation. The key generation method is effective for all public-key cryptosystems of the present invention.

<Study of Security>

The security of the public-key cryptosystem according to the embodiment will be considered. The public-key cryptosystem uses the difficulty of the problem that calculates an integer solution of a diophantine equation X(x₁, . . . , xₙ)=0 as the basis of security.

A decrypting process is to specify a polynomial m(t) from a ciphertext F(x₁, . . . , xₙ, t) given by the following equation:
F(x₁, . . . ,xₙ,t)=m(t)+f(t)·p(x₁, . . . ,xₙ,t)+X(x₁, . . . , xₙ)q(x₁, . . . ,xₙ,t)

The decryption method has, as a point, an operation that assigns integer solutions (c₁, . . . , cₙ) and (g₁, . . . ,gₙ) of X(x₁, . . . , xₙ) to F(x₁, . . . , xₙ, t) and derives the right-hand side of equation (6) by factorization of a polynomial. In the following description, attack methods are classified into four attack methods [Attack 1] to [Attack 4], and it is examined that decryption cannot be achieved without the above operation.

[Attack 1] m(t) is estimated from the form of an expression F(x₁, . . . , xₙ, t).

[Attack 2] A solution except for an integer solution is assigned to calculate m(t).

[Attack 3] m(t) is calculated by various reductions.

[3-1] Reduction by a diophantine equation X(x₁, . . . , xₙ)

[3-2] Reduction by a Prime Number p

[Attack 4] m(t) is calculated by expressing variables x₁, . . . , xₙ as parameters.

[Attack 1] Attack Method of Estimating Plaintext From Form of equation

The polynomial m(t) in which a plaintext is embedded is present in only a part of a term including only t in the ciphertext F(x₁, . . . , xₙ, t) as a variable. Therefore, when the ciphertext F(x₁, . . . , xₙ, t) does not have a term including only t as a variable except for m(t), m(t) can be specified from the form of the ciphertext F(x₁, . . . , xₙ, t). However, when the ciphertext F(x₁, . . . , xₙ, t) is transformed into the following equation by setting c as an arbitrary integer, another constant term cf(t) is apparently present.
F(x₁, . . . ,xₙ)={m(t)+cf(t)}+f(t){p(x₁, . . . , xₙ,t)−c}+X(x₁, . . . , xₙ)_{q}(x₁, . . . ,xₙ,t)

Therefore, m(t) cannot be specified as a term including only t in the ciphertext F(x₁, . . . , xₙ, t) as a variable.

[Attack 2] Attack Method of Assigning Solution Except for Integer Solution

An attack that assigns a solution except for an integer solution to a diophantine equation is considered. In the diophantine equation, an integer solution cannot be easily calculated. However, a real root or a complex-number solution of the diophantine equation can be relatively easily calculated. For descriptive convenience, real roots (r₁, . . . , rₙ) and (s₁, . . . , sₙ) are assigned to the diophantine equation, and the two obtained numbers are subtracted from each other with respect to sides to calculate f(t){p(r₁, . . . , rₙ, t)−p(s₁, . . . , sₙ, t)}. However, since the second factor {p(r₁, . . . , rₙ, t)−p(s₁, sₙ, t)} is an actual number or a complex number, f(t) cannot be calculated by factorization.

[Attack 3] Attack Method by Various Reductions

An attack that applies a reduction to the ciphertext F(x₁, . . . , xₙ, t) to transfer the ciphertext to an easy-to-decipher space and performs decryption in the easy-to-decipher space is considered. In this case, securities related to the following two cases will be considered. Note that to reduce f(x₁, . . . , xₙ, t) by g(x₁, . . . , xₙ) is to calculate a remainder obtained by dividing f(x₁, . . . , xₙ, t) by g(x₁, . . . , xₙ).

[Attack 3-1] Reduction by Diophantine Polynomial X(x₁, . . . , xₙ)

It is known that, when a reduction of diophantine equation X(x₁, . . . , xₙ) is applied to the ciphertext F(x₁, . . . , xₙ, t), a remainder is not uniquely determined when X(x₁, . . . , xₙ) includes two or more variables (for example, see Kazuo Matsuzaka: “Daisu-kei Nyumon”, Iwanami Shoten, Publishers, Theorem 8 on p. 140, (1976) and D. Cocks et al.: “Grebuna-Kitei to Daisu-Tayotai-Nyumon (jyo)”, Springer-Verlag (200)). If a remainder is uniquely determined (using a Gröbner basis or the like), a polynomial p(x₁, . . . , xₙ, t) satisfies the condition (2). For this reason, there is no means that proves whether the determined remainder is a desired remainder m(t)+f(t)ₚ(x₁, . . . , xₙ, t). However, if the ciphertext F(x₁, . . . , xₙ, t) does not include a factor q(x₁, . . . , xₙ, t), a current m(t)+f(t)ₚ(x₁, . . . , xₙ, t) is calculated by merely subtracting X(x₁, . . . , xₙ) from the ciphertext F(x₁, . . . , xₙ, t). When m(t)+f(t)ₚ(x₁, . . . , xₙ, t) is calculated, two appropriate combinations of integers (u₁, . . . , uₙ) and (v₁, . . . , vₙ) (which are not always integer solutions of the diophantine equation) are assigned to the variables (x₁, . . . , xₙ) to make it possible to calculate the polynomial m(t). Therefore, the factor q(x₁, . . . , xₙ, t) is an absolutely imperative factor as far as the attack is prevented.

[Attack 3-2] Reduction by Prime Number p

An attack that reduces the ciphertext F(x₁, . . . , xₙ, t) by a prime number p makes it very easy to solve a problem to calculate a solution of the diophantine equation X(x₁, . . . , xₙ)=0 on a finite field Fₚ. Therefore, the solution is actually calculated to make it possible to derive f(t){p(r₁, . . . , rₙ, t)−p(s₁, . . . , sₙ, t)} (mod p). However, since the solution is merely calculated on the finite field Fₚ, an irreducible polynomial f(t) cannot be calculated by a means such as prime factorization or the like.

On the other hand, when the ciphertext F(x₁, . . . , xₙ, t) does not include the factor p(x₁, . . . , xₙ, t), f(t) (mod p) is calculated by the attack. For this reason, m(t) (mod p) is calculated. In this case, a reduction is performed by various prime numbers p, the polynomial m(t) in which a plaintext is embedded can be calculated from the obtained result on the basis of the chinese remainder theorem. Therefore, the factor p(x₁, . . . , xₙ, t) is an absolutely imperative factor as far as the attack is prevented.

[Attack 4] Attack Method of Expressing Variables x₁, . . . , xₙ as Parameters

A variables xᵢ of the diophantine equation X(x₁, . . . , xₙ) is expressed as a parameter such as xᵢ(t) to make it possible to obtain a one-variable polynomial. At this time, the ciphertext is calculated from the equation (5) as the following equation f(t).
F(t)=m(t)+f(t)ₚ(x₁(t), . . . , xₙ(t),t)+X(x₁(t), . . . , xₙ(t))_{q}(x₁(t), . . . , xₙ(t),t)

In this case, the ciphertext f(t) expressed as a parameter is divided by a diophantine equation X(x₁(t), . . . , xₜ(t), t), a desired remainder “m(t)+f(t) p(x₁(t), . . . , xₙ(t), t)” may be disadvantageously calculated. However, even though the ciphertext is expressed as any parameter, the degree of a polynomial p(x₁(t), . . . , xₙ(t), t) is larger than the degree of the diophantine equation X(x₁(t), . . . , xₙ(t), t) (deg p(x₁(t), . . . , xₙ(t), t)>deg X(x₁(t), . . . , xₙ(t)) because of the condition (3).

For this reason, there is no means that proves that the calculated remainder is the desired remainder “m(t)+f(t) p(x₁(t), . . . , xₙ(t), t)”. The attack is effective even though some variables are replaced with constants. However, in the same consideration as described above, the desired remainder “m(t)+f(t) p(x₁(t), . . . , xₙ(t), t)” cannot be calculated.

<Variation>

Finally, several variations in this embodiment will be described below.

The first variation is a method in which the equation (5) for encryption is transformed. For example, the additions in the equation (5) are replaced with subtractions as shown by F(x₁, . . . , xₙ, t)=m(t)−f(t)ₚ(x₁, . . . , xₙ, t)−X(x₁, . . . , xₙ)_{q}(x₁, . . . , xₙ, t). Even in such transformation, similarly, encryption/decryption can be performed, and the same security as described above can be obtained. In this manner, it is sufficiently possible that the equation for encryption is transformed without departing from the scope of the invention and that a decrypting process is changed accordingly.

The second variation is a method of also embedding a plaintext in the irreducible polynomial f(t). It was described that the irreducible polynomial f(t) is generated at random. However, according to the characteristic feature of the public-key cryptosystem according to the present invention, a person who has no private key cannot easily calculate the irreducible polynomial f(t). For this reason, plaintext information can be embedded in the irreducible polynomial f(t). Therefore, encryption of a larger set of plaintexts can be achieved. On the other hand, since the embedded result f(t) must be an irreducible polynomial, it must be determined in advance that random numbers are assigned to coefficients of a term of a specific degree. Since an extremely large number of irreducible polynomials are present, as described above, even though the plaintext is embedded in some bits, the irreducible polynomials are rarely prevented from being calculated.

The third variation is a method of adding a process of verifying a decryption result to the decrypting process. A ciphertext F(x₁, . . . , xₙ, t) to be transmitted may include a random ciphertext F′ which does not have the configuration shown by the equation (5) because someone intentionally transmits the illegal ciphertext F′ or because a ciphertext F″ which are partially damaged by defective transmission is received. The illegal ciphertexts F′ and F″ can be excluded by a verification process for checking incoincidence (m₁≠m₂) between the two plaintexts.

The fourth variation is a method of using a one-way function such as a hash function h without developing a plaintext into a simple corresponding integer-m and transforming the plaintext into following equation:
m′=m|h(m) (8)

According to the fourth variation, the hash function h is applied to a plaintext m obtained from a decrypted text m′ to determine whether the equation (8) is satisfied, so that the truth of the output decrypted text m′ can be confirmed. On the other hand, a person who will falsify the ciphertext is very hard to give an articulated structure such as m₀′=m₀|h (m₀) with respect to a plaintext m₀′ obtained from the falsified ciphertext F′. Therefore, the fourth variation has an advantage of preventing the illegal ciphertext F′ described in the third variation from being formed. In general, it is known that the configuration of a public-key cryptosystem obtained by applying one-way transformation to the plaintext m has the following characteristic feature. That is, a cipher having security against falsification or security strong to an active attack (a proper ciphertext is formed, decoded by a decryption apparatus, and the ciphertext is decoded by information obtained by the decryption apparatus. This characteristic feature is similarly achieved for the public-key cryptosystem according to the present invention, and the same effect as described above can be expected.

(Concrete Configuration of First Embodiment)

Concrete configurations of a key generation apparatus, an encryption apparatus, and a decryption apparatus in the public-key cryptosystem and algorithms of the apparatuses will be described below while taking a case using two variables as an example.

(Key Generating Apparatus and Flow of Processes)

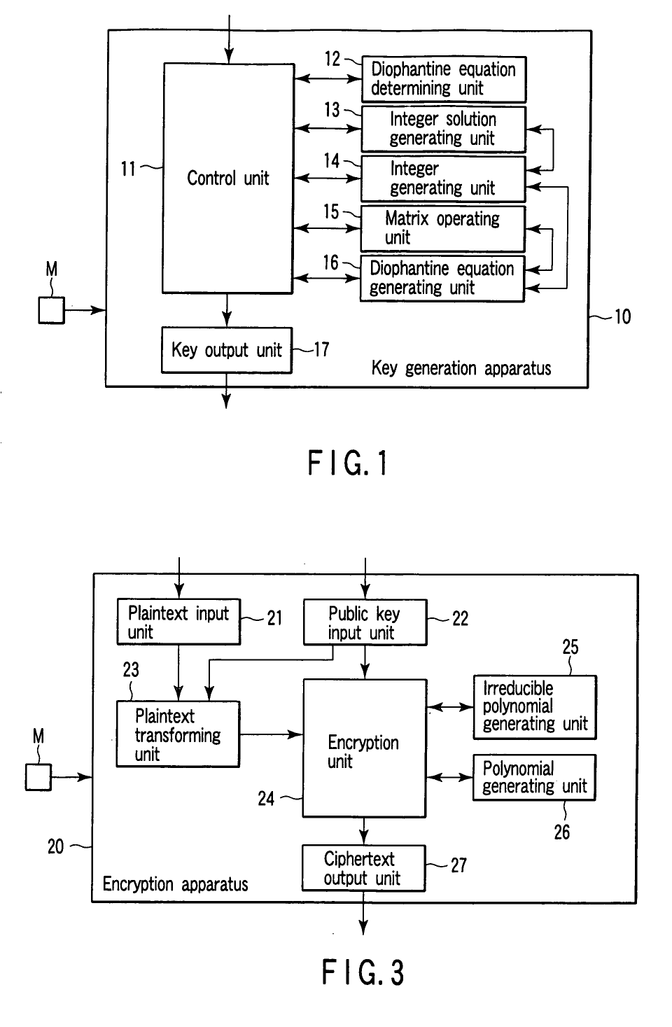

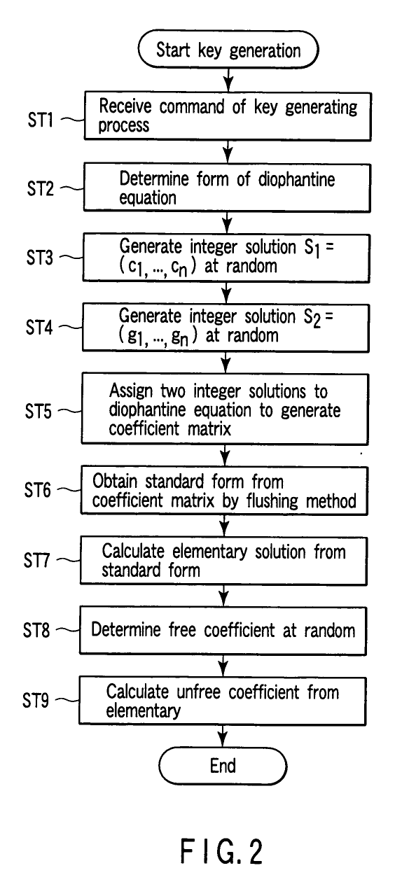

The configuration of the key generation apparatus and a flow of processes in the key generation apparatus will be described below with reference to an entire block diagram shown in FIG. 1 along a flow chart shown in FIG. 2. Note that concrete numerical values and equations (to be described later) are absolutely simple examples to assist understanding and are not always equal to those in actually applied encryption having sufficient security (in particular, with respect to an degree of a polynomial or the like). A key generation apparatus 10 may be realized by a hardware device such as an IC chip having tamper resistance or may be realized by combinations between hardware devices and software. The software consists of a program which is installed from a storage media M or a network in a computer of the apparatus 10 to cause the apparatus 10 to realize the functions. The configuration using software can be similarly realized by the following devices such that the storage media M is also shown in FIGS. 3, 5 and 12.

The key generation apparatus 10 according to the embodiment includes a control unit 11, a diophantine equation determining unit 12, an integer solution generating unit 13, an integer generating unit 14, a matrix operating unit 15, a diophantine equation generating unit 16, and a key output unit 17. In the key generation apparatus 10, the control unit 11 controls the other units 12 to 17 to execute an operation shown in FIG. 2. The key generation apparatus 10 has a memory (not shown) such that input data and output data from the units 11 to 17, data in processing, and the like can be appropriately read/written. The key generation apparatus 10 will be described below in detail.

The key generation apparatus 10 starts the processes when a command to start a key generating process is transmitted from an external device to the control unit 11. When the control unit 11 receives the command (ST1), the control unit 11 requests the diophantine equation determining unit 12 to output a diophantine equation.

In the diophantine equation determining unit 12, as shown in the equation (7), the form of the diophantine equation is determined (ST2), and the form of the equation is output to the control unit 11. The form of the equation is not limited to the form shown in the equation (7), and the form may be really output at random. However, a method of preparing several forms in advance and extracting one from the forms at random may be used.

The control unit 11 outputs an instruction to the integer solution generating unit 13 to generate two integer solutions S₁=(c₁, . . . , cₙ) and S₂=(g₁, . . . , gₙ). The integer solution generating unit 13 generates the integer solutions S₁ and S₂ at random while subsidiarily using the integer generating unit 14 (ST3 and ST4). For descriptive convenience, the apparatus will be concretely explained while taking a diophantine equation having two variables as shown in the equation (7) as an example.

The two generated integer solutions are defined as S₁: (c₁, c₂)=1213, 5724) and S₂: (g₁, g₂)=(6871, 7519). The control unit 11 transmits these integer solutions to the matrix operating unit 15. In the matrix operating unit 15, the two integer solutions are assigned to the equation (7) which is a diophantine equation to calculate the following equation:

$$( \begin{matrix}275943696027627456 & 32764176 & 1213 & 1 \\ 20068742081830559119 & 56535361 & 6871 & 1\end{matrix} ) ( \begin{matrix}{a}_{1} \\ {a}_{2} \\ {a}_{3} \\ {a}_{4}\end{matrix} ) = ( \begin{matrix}0 \\ 0 \\ 0 \\ 0\end{matrix} )$$

thereby obtaining the following coefficient matrix:

$$( \begin{matrix}275943696027627456 & 32764176 & 1213 & 1 \\ 20068742081830559119 & 56535361 & 6871 & 1\end{matrix} )$$

(ST5). The matrix operating unit 15 applies a flushing method to the coefficient matrix to transform the coefficient matrix into the following matrix:

$$( \begin{matrix}275943696027627456 & 32764176 & 1213 & 1 \\ 19792798385802931663 & 23771185 & 5658 & 0\end{matrix} ) \\ -> ( \begin{matrix}275943696027627456 & 32764176 & 1213 & 1 \\ 19792798385802931663 / & 23771185 / & 1 & 0 \\ 5658 & 5658 & & \end{matrix} ) \\ -> ( \begin{matrix}- 22447375009854639961171 / & 3818177083 / & 0 & 1 \\ 5658 & 138 & & \\ 19792798385802931663 / & 23771185 / & 1 & 0 \\ 5658 & 5658 & & \end{matrix} )$$

As a standard form, the following matrix is obtained (ST6).

$$( \begin{matrix}- 22447375009854639961171 / 5658 & 3818177083 / 138 & 0 & 1 \\ 19792798385802931663 / 5658 & 23771185 / 5658 & 1 & 0\end{matrix} )$$

From the standard form, the following relational expression can be obtained:

$$( \begin{matrix}- 22447375009854639961171 / 5658 & 3818177083 / 138 & 0 & 1 \\ 19792798385802931663 / 5658 & 23771185 / 5658 & 1 & 0\end{matrix} ) ( \begin{matrix}{a}_{1} \\ {a}_{2} \\ {a}_{3} \\ {a}_{4}\end{matrix} ) = ( \begin{matrix}0 \\ 0 \\ 0 \\ 0\end{matrix} )$$

For this reason, elementary solutions given by:
a₄=22447375009854639961171/5658a₁−3818177083/138a₂
a₃=−19792798385802931663/5658a₁−23771185/5658a₂
is calculated (ST7). The matrix operating unit 15 transmits the elementary solution to the control unit 11. The control unit 11 transmits the elementary solution to the diophantine equation generating unit 16 to output an instruction that causes the diophantine equation generating unit 16 to output a diophantine equation.

When the diophantine equation generating unit 16 receives the instruction, the diophantine equation generating unit 16 sets a free coefficient in the elementary solution at random (ST8). In this case, for example, coefficients a₁ and a₂ are set at random as a₁=3892 and a₂=2056. In the diophantine equation generating unit 16, unfree coefficients a₃ and a₄ are determined from the free coefficients a₁ and a₂ by using the elementary solution (ST9) to obtain a coefficient vector (a₁, a₂, a₃, a₄)=(3892, 2056, −38516785658796941794378/2829,43682591769016200836744482/2829).

Furthermore, in the diophantine equation generating unit 16, in order to take the coefficient vector (a₁,a₂,a₃,a₄) as an integer vector, the coefficient vector is multiplied by the least common multiple of denominators 2829 to obtain a coefficient vector (a₁, a₂, a₃, a₄)=(11010468, 5816424, −38516785658796941794378, 43682591769016200836744482) of the final diophantine equation. Thereafter, the diophantine equation generating unit 16 transmits the integer vector to the control unit 11.

In the control unit 11, on the basis of the integer vector, a diophantine equation X(x,y) having S₁ and S₂ as integer solutions can be generated as follows:
X(x,y):11010468x²y³+5816424y²−38516785658796941794378x+43682591769016200836744482

When the diophantine equation X(x,y) is output from the key output unit 17, the key generating process is ended.

(Encryption Apparatus and Flow of Processes)

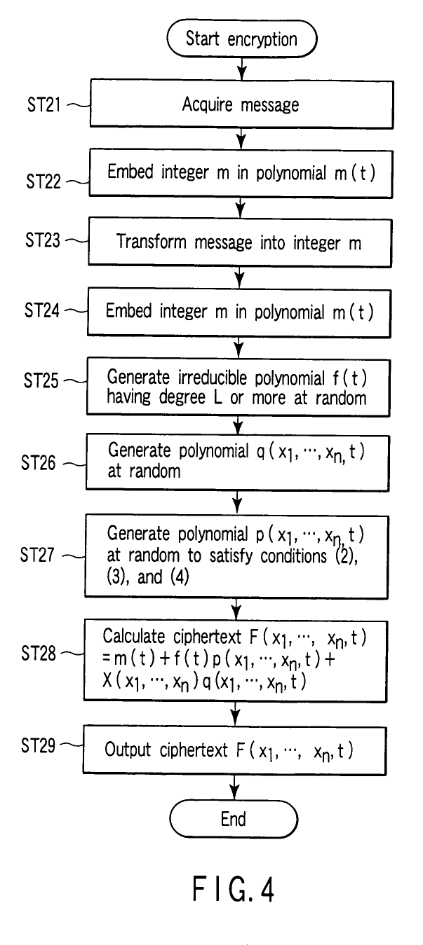

The configuration of the encryption apparatus according to the embodiment and a flow of processes in the encryption apparatus will be described below with reference to an entire block diagram shown in FIG. 3 along a flow chart shown in FIG. 4. An encryption apparatus 20 according to the embodiment includes a plaintext input unit 21, a public-key input unit 22, a plaintext transforming unit 23, an encrypting unit 24, an irreducible polynomial generating unit 25, a polynomial generating unit 26, and a ciphertext output unit 27. In the encryption apparatus 20, the encrypting unit 24 controls the units 21 to 23 and 25 to 27 to execute an operation shown in FIG. 4. The encryption apparatus 20 has a memory (not shown) such that input data and output data from the units 21 to 27, data in processing, and the like can be appropriately read/written. The encryption apparatus 20 will be described below in detail.

The encryption apparatus 20 starts the processes by acquiring a message from the plaintext input unit 21 and acquiring a public key X(x₁, . . . , xₙ) and the minimum degree L of an irreducible polynomial from the public-key input unit 22. As the public key, a “diophantine equation” generated in the example of the key generating process is used. A concrete example of the public key will be described below:
diophantine equation: X(x,y):11010468x²y³+5816424y²−38516785658796941794378x+43682591769016200836744482=0
A degree L (=5) of an irreducible polynomial f(t) generated at random is input independently of the public key.

At the first, the encryption apparatus 20 receives a message from the plaintext input unit 21 (ST21) and receives the public key and the minimum degree L of the irreducible polynomial from the public-key input unit 22 (ST22). The input minimum degree L (=5) of the irreducible polynomial is transmitted to the plaintext transforming unit 23.

In the plaintext transforming unit 23, the message transmitted from the plaintext input unit 21 is separately developed into an integer m (ST23), and the integer m is transformed into a polynomial m(t) having a degree smaller than the minimum degree L of an irreducible polynomial f(t) (ST24). There are various algorithms for transformation. A method of rereading a character code string into an integer is generally used to develop the message into the integer m. As a method of transforming the integer m into a polynomial m(t), a method of dividing the integer m into L blocks each having predetermined number of bits and embedding the integer m in a (L−1)-degree polynomial m(t) having the integers of these blocks as coefficients is generally. In the embodiment, it is assumed that a message can be transformed into a hexadecimal integer m=0×3E54402F8E7C82B92A982398452E3A80 5C948A3025D32493 14204A043C9230D178982CA92C020131. The integer m is also called a plaintext m.

In the plaintext transforming unit 23, the plaintext m is divided by L (=5) as mentioned above, and the plaintext m is embedded in the following (L−1)-degree polynomial m(t), and the resultant polynomial is transmitted to the encrypting unit 24.
m(t)=4491285301393392313+3069242282955651712t+6671108887440204947t²+1450240462060400849t³+8689744586110796081t⁴

On the other hand, the public-key input unit 22 transmits the public key and the minimum degree L of the irreducible polynomial f(t) to the encrypting unit 24.

When the encrypting unit 24 receives the polynomial m(t), the public key, and the minimum degree L of the irreducible polynomial f(t), the encrypting unit 24 transmits the minimum degree L of the irreducible polynomial f(t) to the irreducible polynomial generating unit 25.

The irreducible polynomial generating unit 25 generates a one-variable polynomial having a degree of L or more and stores the polynomial in a memory (not shown). The irreducible polynomial generating unit 25 irreducibly determines the one-variable polynomial in the memory to generate irreducible polynomials f(t) at random (ST25). The irreducible polynomial generating unit 25 returns the obtained irreducible polynomial f(t) having the degree L (=5) to the encrypting unit 24.
f(t)=17133746509475672633+219721297797977219t+9172974197261927t²+87816428187483217681t³+9127865831194057238632t⁴+91297463724832569832t⁵

When the encrypting unit 24 receives the irreducible polynomial f(t), the encrypting unit 24 transmits the diophantine equation X included in a public key to the polynomial generating unit 26.

When the polynomial generating unit 26 receives the diophantine equation X, the polynomial generating unit 26 generates a random 3-variable polynomial q(x,y,t) (ST26) and returns the polynomial q(x,y,t) to the encrypting unit 24. In this case, for descriptive convenience, the 3-variable polynomial q(x,y,t) is given by the following equation:
q(x,y,t)=2xyt²+34y²t+53+t⁵

When the encrypting unit 24 obtains the 3-variable polynomial q(x,y,t), the encrypting unit 24 generates a random 3-variable polynomial p(x,y,t) which satisfies the conditions (2), (3), and (4) (ST27). In this case, the 3-variable polynomial p(x,y,t) is given by the following equation:
p(x,y,t)=7x³y⁴t+15x³yt²+7x²y⁵+65x²y³t+4xy³t²+3y⁴t⁴+5y²t+5xy²t²+43xy+3x+6x²y+4

This 2-variable polynomial p(x,y,t) satisfies the conditions (2), (3), and (4).

The encrypting unit 24 calculates and develops a ciphertext F(x,y,t) on the basis of the equation (5) by using the polynomial m(t), the irreducible polynomial f(t), and the polynomials p(x,y,t) and q(x,y,t) which are obtained in the above processes and diophantine equation X(x,y)=0 serving as a public key (ST28).

The ciphertext F(x,y,t) is given by the following equation:
F(x,y,t)=308270472y²+6707800784229252655t²+421250939249895962105t³+36521031954553531659485t⁴−2041338238676709488084135x+3948127474147560588t+583554804x²y³+257006197642135089495x³yt²+43682956995562996956071518t⁵+19936225566329708431x²y⁵+51401239528427017899y⁴t⁴+1485208205815283375827675553y²t+736751099907453923219xy+102802479056854035798x²y+659163893393931657y⁴t⁵+1098606488989886095y²t²+659163893393931657tx+27518922591785781t⁶y⁴+45864870986309635t³y²+27518922591785781t²x+263449284562449653043t⁷y⁴+439082140937416088405t⁴y²+263449284562449653043t³x+27383597493582171715896t⁸y⁴+45639329155970292009584t⁵y²+27383597493582171715896t⁴x+273892391174497709496t⁹y⁴+456487318624162849160t⁶y²−38242893267622444084882t⁵x+197758416y⁴t+1538049084960196445tx²y⁵+119936225566329708431x³y⁴t+1113693523115918721145x²y³t+68534986037914323380xy³t²+85668732547378363165xy²t²+2315177436784129983643540391+351265712749932870724t⁶+36511463324776228954528t⁷+365189854899330279328t⁸+87365183932470292155751825xyt²+1538049084607861469x³y⁴t²+3295819466969658285x³yt³+14281884356868519235x²y³t²+878885191191908876xy³t³+1098606488989886095xy²t³+64210819380833489t³x³y⁴+137594612958928905t⁴x³y+64210819380833489t²x²y⁵+596243322822025255t³x²y³+36691896789047708t⁴xy³+45864870986309635t⁴xy²−77033516279748700017194t²x²y+614714997312382523767t⁴x³y⁴+1317246422812248265215t⁵x³y+614714997312382523767t³x²y⁵+5708067832186409149265t⁴x²y³+351265712749932870724t⁵xy³+439082140937416088405t⁵xy²+776106412061778360283t³xy+526898569124899306086t³x²y+63895060818358400670424t⁵x³y⁴+136917987467910858579480t⁶x³y+63895060818358400670424t⁴x²y⁵+593311279027613731521548t⁵x²y³+36511463324776228954528t⁶xy³+45639329155970286193160t⁶xy²+392498230741344461261176t⁴xy+54767194987164343431792t⁴x²y+639082246073827988824t⁶z³y⁴+1369461955872488547480t⁷x³y+639082246073827988824t⁵x²y⁵+5934335142114117039080t⁶x²y³+365189854899330279328t⁷xy³+456487318624162849160t⁷xy²+3925790940167800502776t⁵xy+547784782348995418992t⁵x²y+9448015805313020417txy+1318327786787863314tz²y−1309570712399096021008852xy²t

The encrypting unit 24 outputs the ciphertext F(x,y,t) (if necessary, transforms the ciphertext according to a predetermined format) from a ciphertext output unit 29 (ST29) to end the encrypting process.

The first variation is naturally established when the equation (5) in the encrypting process according to the embodiment is merely transformed.

The second variation is similarly established as follows. That is, in the plaintext transforming unit 23, a message is developed into the integer m by the same method as that in the embodiment, and the integer m is embedded in the coefficients having higher degrees of the polynomial m(t) and the irreducible polynomial f(t). In the irreducible polynomial generating unit 25, coefficients of the remaining degrees of the irreducible polynomial f(t) are set at random.

The fourth variation is automatically established by adding a process of causing the plaintext transforming unit 23 to transform the plaintext m into the equation (8) by using a predetermined hash function h to form a new plaintext m′.

(Decryption Apparatus and Flow of Processes)

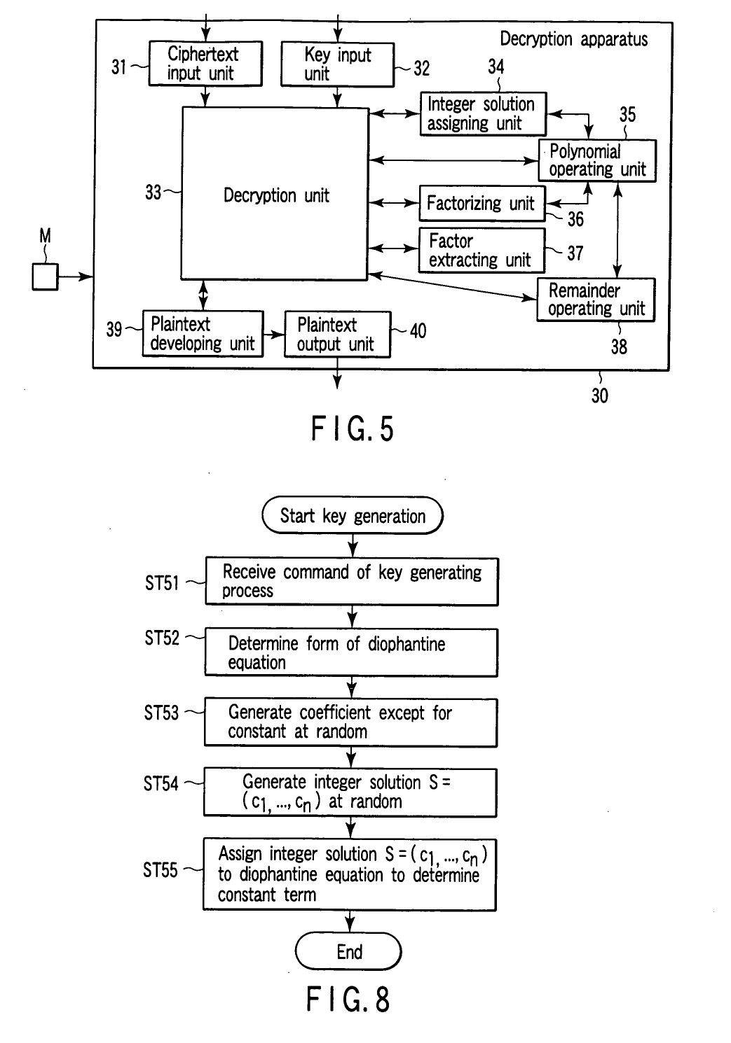

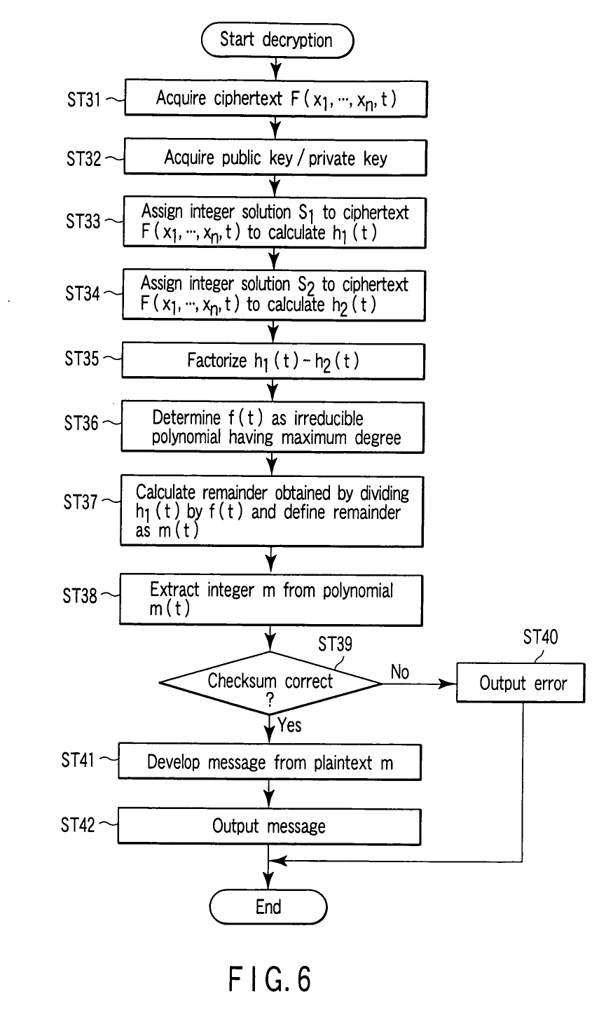

Finally, the configuration of the decryption apparatus according to the embodiment and a flow of processes in the decryption apparatus will be described below with reference to an entire block diagram shown in FIG. 5 along a flow chart shown in FIG. 6. A decryption apparatus 30 according to the embodiment includes a ciphertext input unit 31, a key input unit 32, a decrypting unit 33, an integer solution assigning unit 34, a polynomial operating unit 35, a factorizing unit 36, a factor extracting unit 37, a remainder operating unit 38, a plaintext developing unit 39, and a plaintext output unit 40. In the decryption apparatus 30, the units 31, 32, and 34 to 40 are controlled by the decrypting unit 33 to execute an operation shown in FIG. 6. The decryption apparatus 30 has a memory (not shown) such that input data and output data from the units 31 to 40, data in processing, and the like can be appropriately read/written. The decryption apparatus 30 will be concretely described below with reference to an example using two variables as in the encryption apparatus.

The decryption apparatus 30 starts the process by acquiring a ciphertext F(x,y,t) from the ciphertext input unit 31 (ST31) and acquiring a public key X(x,y) and a private key from the key input unit 32. In this case, the private key means two integer solutions (ST32). As the two integer solutions, the integer solutions S₁ and S₂ obtained in the key generating steps ST3 and ST4 are used. The acquired ciphertext and the key information are transmitted to the decrypting unit 33 to start the decrypting process.

The decrypting unit 33 transmits the ciphertext F(x,y,t) and the integer solution S₁ to the integer solution assigning unit 34. The integer solution assigning unit 34 assigns the integer solution S₁ to the ciphertext F(x,y,t). If necessary, the polynomial operating unit 35 is used to obtain a polynomial h₁(t) given by the following equation (ST33).
h₁(t)=F=(c₁,c₂,t)=3527341299571426390976598978201630764869816t²+5557803006314836768552024109636143952314708328t³+578857334307900168111112560662980006111230101825t⁴+243695995488491091920282541363606072045293157t+1281969701609§0256824003737829837877851685117240t⁵+1224442062059985610383125826037792538015925604t⁶+379895634699190121450769291979788352t⁷+29396051726703460789399375763041361824t⁸+294021079604424138169003416549636096t⁹+1084351549748593371057279489984490404763240584

In this case, the polynomial operating unit 35 performs addition, subtraction, multiplication, and division of the polynomial. Similarly, the integer solution assigning unit 34 assigns the integer solution S₂ to F(x,y,t) to obtain a polynomial h₂(t) given by the following equation (ST34).
h₂(t)=F=(g₁,g₂,t)=166752184201166781278922162095433677263005945t²+697518263090371761696566652924252873652686940385t³+73132269946405377505844373625093560021736471016247t⁴+126096449506133034186734182022472731299160670602t+66972302228820788687788692176728074762194804222707t⁵+662608520426224203476170818095976298914539017521t⁶+5249049117419875150438757236067065603t⁷+87524742526526457321868989558337481944t⁸+875427745501332476914229117891148216t⁹+136078871346552714135511292887338991815140861776

The obtained assignment results h₁(t) and h₂(t) are output from the integer solution assigning unit 34 to the decrypting unit 33.

The decrypting unit 33 transmits the assignment results h₁(t) and h₂(t) to the polynomial operating unit 35 to subtract the results from each other. The subtraction result is transmitted to the factorizing unit 36 to factorize the result (ST35), thereby obtained a factorization result as shown in equation (9). At this time, the factorization result is stored in the memory (not shown).
h₁(t)−h₂(t)=−1663994500712096386398245021976135141865226129t²−691960460084056924928014628814616729700372232057t³−72553412612097477337733261064430580015625240914422t⁴−125852753510644543094813899481109125227115377445t−66844105258659798430964688438898236884343119105467t⁵−661384078364164217865787692269938506376523091917t⁶−4869153482720685028987987944087277251t⁷−58128690799822996532469613795296120120t⁸−581406665896908338745225701341512120t⁹−134994519796804120764454013397354501410377621192=−(6368267443324035t⁴+47207390066116938 t²+7244276576254630748557270133t+7878867574126099677806966024)(17133746509475672633+219721297797977219t+9172974197261927t²+87816428187483217681t³+9127865831194057238632t⁴+91297463724832569832t⁵) (9)

The decrypting unit 33 causes the factor extracting unit 37 to extract a prime factor having the maximum degree from the factorization result in the memory to determine an irreducible polynomial f(t) (ST36).

The decrypting unit 33 transmits the irreducible polynomial f(t) and the assignment result h₁(t) to the remainder operating unit 38. The remainder operating unit 38 divides the assignment result h₁(t) by the irreducible polynomial f(t), calculates the polynomial m(t) as a remainder (ST37), transforms the polynomial m(t) into an integer m, and transmits the integer m to the decrypting unit 33 (ST38). The decrypting unit 33 transmits the integer m to the plaintext developing unit 39 as a plaintext m.

The plaintext developing unit 39 confirms a checksum to check the appropriateness of the plaintext (ST39). When an incorrect checksum means that an erroneous ciphertext is input, an error is output to end the process (ST40). When the checksum is correct, the possibility of performing correct decryption is considerably high. For this reason, the plaintext developing unit 39 develops a message from the plaintext m (ST41), and the obtained message is output from the plaintext output unit 40 to end the process (ST42).

Furthermore, as a matter of course, the number of plaintexts free from checksums is not small. For this reason, forms may be realized without checksums. In this case, the plaintext m obtained in step ST38 is output.

In any case, the decrypting unit 33 transmits the obtained plaintext m to the plaintext developing unit 39 to cause the plaintext developing unit 39 to develop the plaintext m. The message is output from the plaintext output unit 40 to end the decrypting process.

The first variation is established by an apparent modification even in the decrypting process according to the embodiment.

The second variation is also established in the embodiment such that f(t) calculated in the middle of the decrypting process is transmitted to the plaintext developing unit 39 as a part of the plaintext to cause the plaintext developing unit 39 to develop the plaintext by combining m(t) and f(t).

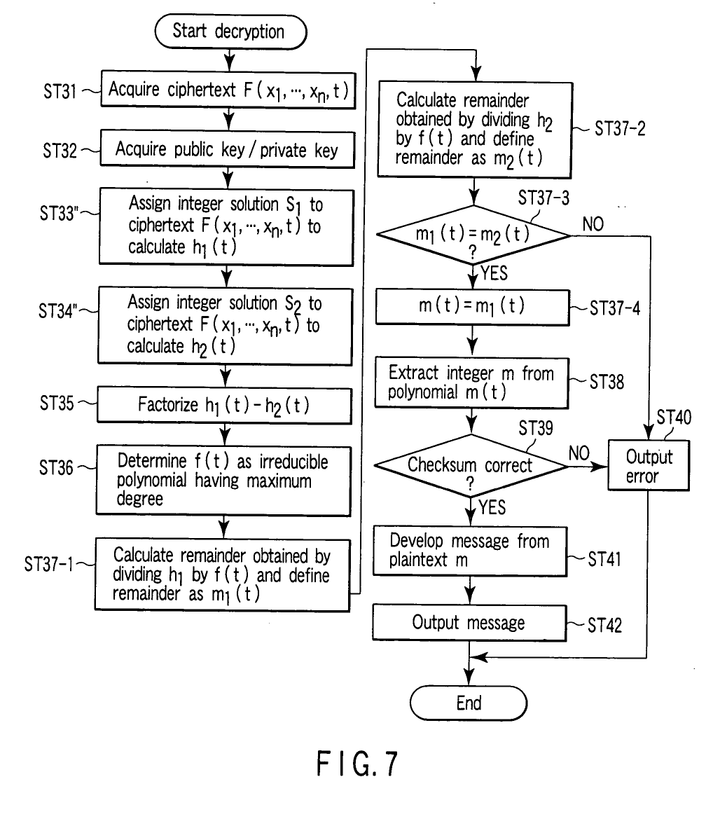

The algorithm of the third variation is shown in FIG. 7. The entire block diagram of the third variation is shown in FIG. 5. As described in step ST37, the decrypting unit 33 causes the remainder operating unit 38 to divide h₁(t) by f(t) and calculates a plaintext polynomial m₁(t) as a remainder (ST37-1). The decrypting unit 33 uses the remainder operating unit 38 to divide h₂(t) by f(t), and obtains a plaintext polynomial m₂(t) as a remainder (ST37-2).

In the decrypting unit 33 checks whether the two polynomials m₁(t) and m₂(t) are equal to each other (ST37-3). Unequal polynomials (ST37-3; NO) means that the ciphertext is not correct. For this reason, the decrypting unit 33 outputs an error to end the process (ST40).

When the polynomials are equal to each other (ST37-3; YES), the plaintext developing unit 39 develops the plaintext m from the plaintext m₁(t) as in the decrypting process (ST37-4, ST38), and the plaintext developing unit 39 confirms a checksum of the plaintext to check the appropriateness of the plaintext (ST39). The subsequent processes are the same as those in the embodiment.

The fourth variation can be realized as follows. That is, first, the plaintext developing unit 39 develops a plaintext m′ by the same means as that in the embodiment and confirms that the equation (8) is satisfied to the developed plaintext m′ (by using a predetermined hash function h). As a result of the confirmation, when the equation (8) is not satisfied, an error is output. When the equation (8) is satisfied, the obtained message is transmitted to the plaintext output unit 40. The fourth variation can also be used together with the third variation by performing the confirmation based on the equation (8) as a checksum (by the same method as in the third variation).

This is the end of the explanation of the concrete configurations of the key generation apparatus, the encryption apparatus, and the decryption apparatus according to the present invention in the first embodiment.

As described above, according to the embodiment, the encryption apparatus 20, the decryption apparatus 30, or the key generation apparatus 10 of the public-key encryption method which uses the two integer solutions S₁ and S₂ of the diophantine equation X as a private key and which uses, as the basis of security, the problem that calculates the integer solutions of the diophantine equation having no general solution algorithm are realized. For this reason, the security can be assured even if a quantum computer appears, and a public-key encryption method which can be securely realized by an existing computer and which may be realized in a low-electric-power environment can be constituted.

### SECOND EMBODIMENT

The second embodiment of the present invention will be described below.

A public key according to the embodiment is the following diophantine equation X.
Diophantine equation: X(x₁, . . . ,xₙ)=0.

A private key is the following integer solution S. Integer solution of diophantine equation X: S (c₁, . . . , cₙ)

The second embodiment is consideration different from the first embodiment in that the private key is one integer solution. In the second embodiment, the size of the private key is small as a matter of course, and the degree of freedom of key generating (to be described later) advantageously increases.

(Encrypting Process)

An outline of an encrypting process in the embodiment will be described below. The encrypting process is almost the same as that of the first embodiment. However, unlike in the first embodiment, one ciphertext F(x₁, . . . , xₙ, t) is generated, the two ciphertexts F₁(x₁, . . . , xₙ, t) and F₂(x₁, . . . , xₙ, t) are generated.

More specifically, in the second embodiment, by using common f(t), the same means as that in the first embodiment generates two random combinations of polynomials (q₁(x₁, . . . , xₙ, t) and polynomials q₂(x₁, . . . , xₙ, t) and (p₁(x₁, . . . , xₙ, t) and p₂(x₁, . . . , xₙ, t)) which are different from each other to generate the following two ciphertexts F₁(x₁, . . . , xₙ, t) and F₂(x₁, . . . , xₙ, t). F₁(x₁, . . . , xₙ, t)=m(t)+f(t)p₁(x₁, . . . , xₙ, t)+X(x₁, . . . , xₙ)q₁(x₁, . . . , xₙ, t) F₂(x₁, . . . , xₙ, t)=m(t)+f(t)p₂(x₁, . . . , xₙ, t)+X(x₁, . . . , xₙ)q₂(x₁, . . . , xₙ, t)

In the ciphertexts, p₁(x₁, . . . , xₙ, t) and p₂(x₁, . . . , xₙ, t) satisfy the conditions (2) and (3), and must satisfy the condition (4) (for the same reason as in the first embodiment).

When a receiver receives the ciphertexts F₁(x₁, . . . , xₙ, t) and F₂(x₁, . . . , xₙ, t), the receiver performs decryption by the following manner using her/his own private key S. The integer solution S is assigned to the ciphertexts F₁(x₁, . . . , xₙ, t) and F₂(x₁, . . . , xₙ, t) to calculate the following two equations h₁ and h₂ by the same idea as that in the first embodiment.
h₁(t)=F₁(c₁, . . . ,cₙ,t)=m(t)+f(t)p₁(c₁, . . . ,cₙ,t)
h₂(t)=F₂(c₁, . . . ,cₙ,t)=m(t)+f(t)p₂(c₁, . . . ,cₙ,t)

The two equations are subtracted from each other with respect to sides to calculate the following equations h₁(t)−h₂(t).
h₁(t)−h₂(t)=f(t){p₁(c₁, . . . ,cₙ,t)−p₂(c₁, . . . ,cₙ,t)}

Thereafter, the calculation result h₁(t)−h₂(t) are factorized to determine an irreducible polynomial having the highest degree as f(t). Since the subsequent processes are the same as those in the first embodiment, a description thereof will be omitted.

(Key Generating Process)

At last, the key generation method in the embodiment will be described below. The key generating of the embodiment is performed such that a section S is selected at random as in the first embodiment to constitute a diophantine equation corresponding to the section S.

In the second embodiment, unlike in the first embodiment, a configuration may be made such that one integer solution is satisfied, and a key having a degree of freedom higher than that in the first embodiment can be generated easily more than the key in the first embodiment.

Here, the key generating will be described by taking, as an example, a diophantine equation, which has the form of the equation (7) also exemplified in the first embodiment, of diophantine equations. More specifically, it is considered that a diophantine equation having two variables given by x₁=x and x₂=y. In this equation, a₁, . . . , a₄ are coefficients and integers. When a diophantine equation is used as a public key of a public-key cryptosystem, an equation such as the equation (7) including a constant term is desirable. This is because, when an equation has no constant term, a trivial solution (0, . . . , 0) is present to give an important hint for decryption. Coefficients a₁, a₂, and a₃ are generated except for the coefficients of constant terms at random. The integer solution S=(c₁,c₂) is assigned to the diophantine equation X(x,y)=0 to obtain the following equation.
a₁c₁²c₂³+a₂c₂²+a₃c₁+a₄=0

From this equation, a constant term a₄ is obtained by the following manner.
a₄=−a₁c₁²c₂³−a₂c₂²−a₃c₁

The key generation method not only can be applied to all diophantine equations having constant terms, but also is free from restriction to an integer solution at all. This point is a different point between the first and second embodiment.

Variations described in the first embodiment are also established in the embodiment.

<Study of Security>

The security of a public-key cryptosystem according to the present invention will be considered below. Basically, the study of security in the first embodiment is directly used as the study of security in the second embodiment. The second embodiment is different from the first embodiment in that two ciphertexts are used. Security of this part will be considered. When the ciphertexts F₁(x₁, . . . , xₙ, t) and F₂(x₁, . . . , xₙ, t) are subtracted from each other, the following equation is obtained.
F₁(x₁, . . . ,xₙ,t)−F₂(x₁, . . . ,xₙ,t)=f(t)((p₁(x₁, . . . ,xₙ,t)−p₂(x₁, . . . ,xₙ,t))−X(x₁, . . . ,xₙ)((q₁(x₁, . . . ,xₙ,t)−q₂(x₁, . . . , xₙ,t))

In this equation, although the polynomial m(t) is eliminated, p₁(x₁, . . . ,xₙ,t)≠p₂(x₁, . . . ,xₙ,t) and q₁(x₁, . . . ,xₙ, t)≠q₂(x₁, . . . , xₙ, t) are satisfied, and an n-variable polynomial is not always uniquely factorized. For this reason, information cannot be rarely obtained from the factors of the polynomial.

(Concrete Configuration of Second Embodiment)

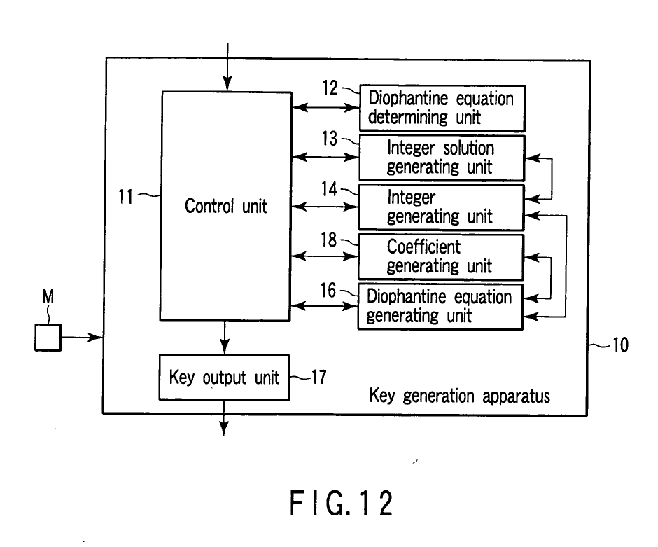

Concrete configurations of a key generation apparatus, an encryption apparatus, a decryption apparatus in a public-key cryptosystem according to the embodiment and algorithms thereof will be described below with reference to an example using two variables. The configuration of the key generation apparatus according to the embodiment and a flow of processes in the key generation apparatus will be described below with reference to an entire block diagram shown in FIG. 12 along a flow chart shown in FIG. 8. The embodiment shows a configuration premised on the diophantine equation shown as the equation (7). Although concrete numerical values and equations are absolutely simple examples to assist understanding, the numerical values and the equations are not always equal to those in actually applied encryption having sufficient security (in particular, with respect to an degree of a polynomial or the like).

The key generation apparatus 10 according to the embodiment is started by transmitting a command to start a key generating process from an external device or the like to the control unit 11. When the control unit 11 receives the command (ST51), the control unit 11 requests the diophantine equation determining unit 12 to output a diophantine equation.

In the diophantine equation determining unit 12, the form of the diophantine equation having coefficients as variables as shown in the equation (7) is determined (ST52), and the form of the equation is output to the control unit 11. A method of outputting the form of the equation is as described in step ST2.

The control unit 11 transmits the diophantine equation to a coefficient generating unit 18.

When the coefficient generating unit 18 receives the diophantine equation, the coefficient generating unit 18 generates coefficients a₁, a₂, and a₃ except for the coefficients of constant terms included in the diophantine equation at random (ST53) and transmits the obtained coefficients a₁ (=23), a₂ (=387), and a₃ (=38) to the control unit 11.

The control unit 11 sets the received coefficients a₁, a₂, and a₃ in the diophantine equation and stores the resultant diophantine equation in a memory (not shown). Thereafter, the control unit 11 requests the integer solution generating unit 13 to generate an integer solution S. The integer solution generating unit 13 calculates two random integers in response to the request to generate an integer solution S=(c₁,c₂)=(1213,1873) at random (ST54), and transmits the obtained integer solution S=(c₁,c₂) to the control unit 11.

The control unit 11 temporarily stores the integer solution S=(c₁,c₂) in the memory (not shown).

Thereafter, the control unit 11 transmits the integer solution S=(c₁,c₂) and the diophantine equation in which the coefficients a₁, a₂, and a₃ are set to the diophantine equation generating unit 16. The diophantine equation generating unit 16 assigns the integer solution S=(c₁,c₂) to the diophantine equation X(x, y)=0 to calculate a constant a₄ (=−222363126905964496) (ST55). Thereafter the diophantine equation generating unit 16 transmits the coefficient a₄ to the control unit 11.

With the above operation, as shown in equations (10) and (11), a diophantine equation X serving as a public key and an integer solution S serving as a private key are obtained.
X(x,y):23x²y³+387y²+38x−222363126905964496 (10)
S:(c₁,c₂)=(1213,1873) (11)
(Encrypting Apparatus and Flow of Processes)

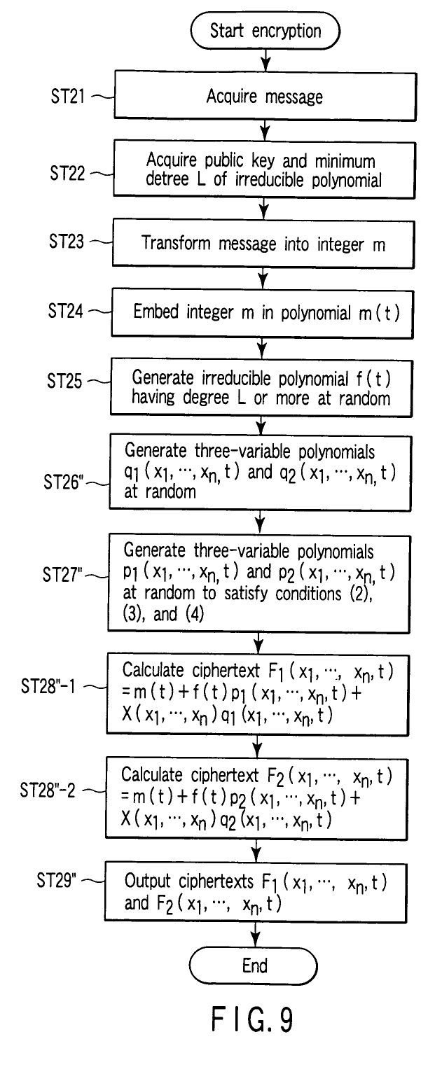

The configuration of the encryption apparatus according to the embodiment and a flow of processes in the encryption apparatus will be described below with reference to an entire block diagram shown in FIG. 3 along a flow chart shown in FIG. 9. The encryption apparatus 20 according to the embodiment starts the processes by acquiring a message from a plaintext input unit 21 and acquiring a public key X(x₁, . . . , xₙ) and the minimum degree L of a irreducible polynomial from a public-key input unit 22. As the public key, as described in the example of the key generating process, a “diophantine equation” is used, and a “minimum degree L of an irreducible polynomial” determined by a transmitter is used. A concrete example will be described below:
diophantine equation X: 23x²y³+387y²+38x−222363126905964496
where the minimum degree L of the irreducible polynomial is set at 5.

First, the encryption apparatus 20 receives a message from the plaintext input unit 21 (ST21), and receives the public key and the minimum degree of the irreducible polynomial from the public-key input unit 22 (ST22). Of the input public key and the input minimum degree of the irreducible polynomial, the minimum degree L (=5) of the irreducible polynomial f(t) is transmitted to a plaintext transforming unit 23.

In the plaintext transforming unit 23, a message transmitted from the plaintext input unit 21 is separately transformed into a polynomial having a degree lower than the minimum degree L of the irreducible polynomial (ST23). The algorithm for the transformation is described in the first embodiment. In this case, since L=5 is satisfied, it is assumed that the message can be transformed into 4-degree polynomial m(t).
m(t)=4491285301393392313+3069242282955651712t+6671108887440204947t²+1450240462060400849t³+8689744586110796081t⁴

In the plaintext transforming unit 23, the polynomial m(t) is transmitted to an encrypting unit. On the other hand, the public-key input unit 22 transmits the public key to the encrypting unit 24.

When the encrypting unit 24 receives the polynomial m(t) and the public key and the minimum degree L of the irreducible polynomial, the encrypting unit 24 transmits the minimum degree L of the irreducible polynomial to an irreducible polynomial generating unit 25 (ST24).

The irreducible polynomial generating unit 25, as described above, generates an irreducible polynomial f(t) having the degree L at random (ST25) and returns the obtained irreducible polynomial f(t) having the degree L (=5) to the encrypting unit 24.
f(t)=17133746509475672633+219721297797977219t+9172974197261927t²+87816428187483217681t³+9127865831194057238632t⁴+91297463724832569832t⁵

When the encrypting unit 24 receives the irreducible polynomial f(t), the encrypting unit 24 transmits the diophantine equation X serving as a public key to a polynomial generating unit 26. When the polynomial generating unit 26 receives the diophantine equation X, the polynomial generating unit 26 generates random polynomials q₁(x,y,t) and q₂(x,y,t) each having three variables (ST26″), and the polynomial generating unit 26 returns the polynomials q₁(x,y,t) and q₂(x,y,t) to the encrypting unit 24. In this case, the polynomials q₁(x,y,t) and q₂(x,y,t) are given by the following equations for descriptive convenience:
q₁(x,y,t)=13x²y³t+378y²t³+34xt⁵+93q₂(x,y,t)=26x³yt+52y²xt³+29

When the encrypting unit 24 receives the 3-variable polynomials q₁(x,y,t) and q₂(x,y,t), the encrypting unit 24 causes the polynomial generating unit to generate different 3-variable polynomials p₁(x,y,t) and P₂(x,y,t) which satisfy the conditions (2), (3), and (4) (ST27″). In this case, the 3-variable polynomials p₁(x,y,t) and p₂(x,y,t) are given by the following equations:
p₁(x,y,t)=4x⁴y⁴t²+5x⁴y⁶t+7x³y³t³+3x²y⁵+34x²y³t+6x²yt+3xy²+86y⁴t+54y²+5t+4p₂(x,y,t)=23x5y⁴t²+4x³t+43x³y⁵t⁴+4x²y³t+8x²y²+34x³yt+5xy²t⁴+21x²y+7y²+7t³+5

The respective terms satisfy relational expressions having degrees shown in the equations (2), (3), and (4).

The encrypting unit 24 uses the polynomial m(t), the irreducible polynomial f(t), the polynomials p₁(x,y,t) and q₁(x,y,t) which are obtained by the above processes and the diophantine equation X(x, y) serving as a public key to calculate and develop the ciphertext F₁(x,y,t) on the basis of the equation (5) (ST28″-1). In this case, the equation (5) is applied such that p(x,y,t) and q(x,y,t) are reread as p₁(x,y,t) and q₁(x,y,t), respectively. The ciphertext F₁(x,y,t) is given by the following equation in an example of the embodiment.
F₁(x,y,t)3534x+89616860021525923753t+68534986037902690532x⁴y⁴t²+2139x²y³+925222311511686358173y²+7806407273219138750t²+352761818082979581208t³+36959235210299755839014t⁴+46004519010869616472488t⁵+119936225566329708431x³y³t³+51401239528427017899x²y⁵+51401239528427017899xy²+1473502199814907846438y⁴t+4658033860153639175286y²t³−7560346314802792864xt⁵+18896031610626040834y⁴t²+11864950081090769826ty²+788875780964672008t³y⁴+495340606652144058t²y²+7552212824123556720566t⁴y⁴+784996461482688922522352t⁵y⁴+492904754884479090886128t⁴y²+7851581880335601005552t⁶y⁴+4930063041140958770928t⁵y²+1292x²t⁵+85668732547378363464x⁴y⁶t+579656660672395331074x²y³t+102802479056854035798x²yt+456487318624162849160t⁶+878885191191908876x⁴y⁴t³+1098606488989886095x⁴y⁶t²+1538049084585840533x³y³t⁴+7470524125131225446x²y³t²+1318327786787863314x²yt²+36691896789047708t⁴x⁴y⁴+45864870986309635t³x^{hu 4}y⁶+64210819380834271t⁵x³y³+27518922591785781t²x²y⁵+311881122706905518t³x²y³+55037845183571562t³x²y+27518922591785781t²xy²+351265712749932870724t⁵x⁴y⁴+439082140937416058405t⁴x⁴y⁶+614714997312382523767t⁶x²y³+263449284562449661737t³x²y⁵+2985758558374429401154t⁴x²y³+526898569124899306086t⁴x²y+263449284562449667407t³xy²+36511463324776228954528t⁶x⁴y⁴+45639329155970286193160t⁵x⁴y⁶+63895060818358400670424t⁷x³y³+27383597493582171715896t⁴x²y⁵+310347438260597946113488t⁵x²y³+54767194987164343431792t⁵x²y+27383597493582171715896t⁴xy²+365189854899330279328t⁷x⁴y⁴+456487318624162849160t⁶x⁴y⁶+639082246073827988824t⁸x³y³+273892391174497709496t⁵x²y⁵+3104113766644307374288t⁶x²y³+547784782348995418992t⁶x²y+273892391174497722654t⁵xy²+659163893393936688tx²y⁵+659163893393931657txy²+494x³y³t+52346500537041384717

The encrypting unit 24 similarly uses the polynomial m(t), the irreducible polynomial f(t), the polynomials p₂(x,y,t) and q₂(x,y,t), and the diophantine equation X(x, y) serving as a public key to calculate and develop the ciphertext F₂(x,y,t) (ST28″-2). The ciphertext F₂(x,y,t) is given by the following equation in the example of the embodiment.
F₂(x,y,t)=702531425499865743424t³x²y²+3776106412061778360283t⁷x³y⁵+1102x+4167848771945537807t+730379709798660558656t⁵x²y²+394076169717940470559x⁵y⁴t²+2985758558374429401154t⁴x³y+667x²y³+83711487168498785094+2019777848312114006663t⁵x⁵y⁴+119936225566329719654y²+6716973758426514582t²+560468606965806197685t³+45649556949640982829774t⁴+392498230741344461261176t⁸x³y⁵+45639329155970286193160t⁸xy²+209940914117463316488536t⁶x⁵y⁴+736751099907453923219x³y⁵t⁴+439082140937416088405t⁷xy²+598x⁵y⁴t+7470524125131225446x³yt²+5053589849353476037x⁵y⁴t³+456551529443543682649t⁵+311881122706905518t³x³y+576765940022617792626x³yt+1196x³y⁵t³+614714997312382523767y²t³+1538049084585840533ty²+64210819380833489t²y²+63895060818358400670424t⁴y²+639082246073827988824t⁵y²+3925790940167800502776t⁹x³y⁵+9448015805313020417x³y⁵t⁵+988x⁴yt+210978406537024321t⁴x⁵y⁴+394437890482262861t⁶x³y⁵+68534986037902690532x²y³t+4614147253757521599x²yt+614714997312382523767t⁶+878885191191908876x²y³t²+192632458142500467x²yt²+36691896789047708t³x²y³+1844144991937147571301t³x²y+351265712749932870724t⁴x²y³+191685182455075202011272t⁴x²y−11562882599110153792t³xy²+36511463324776228954528t⁵x²y³+1917246738221483966472t⁵x²y+85668732547378363165t⁴xy²+365189854899330279328t⁶x²y³+1098606488989886095t⁵xy²+2099841665671149106136t⁷x⁵y⁴+10062x³y³t+310347438260597946113488t⁵x³y+73383793578095416t²x²y²+1757770382383817752tx²y²+20124y⁴t³x+45864870986309635t⁶xy²+456487318624162849160t⁹xy²+359808676698989125293x²y+3104113766644307374288t⁶x³y+73022926649552457909056t⁴x²y²+36511463324776228954528t⁵x³+365189854899330279328t⁶x³+68534986037902690532x³t+63895060818358400670424t⁷+639082246073827988824t⁸+137069972075805381064x²y²+878885191191908876x³t²+36691896789047708t³x³+351265712749932870724t⁴x³

The encrypting unit 24 outputs these ciphertexts F₁(x,y,t) and F₂(x,y,t) from the ciphertext output unit 29 (if necessary, the ciphertexts are transformed in accordance with a predetermined format) to end the encryption process.

Of the variations in the first embodiment, the variations except for the third variation are also established with the same configuration in the encryption apparatus 20 according to the second embodiment.

(Decrypting Apparatus and Flow of Processes)

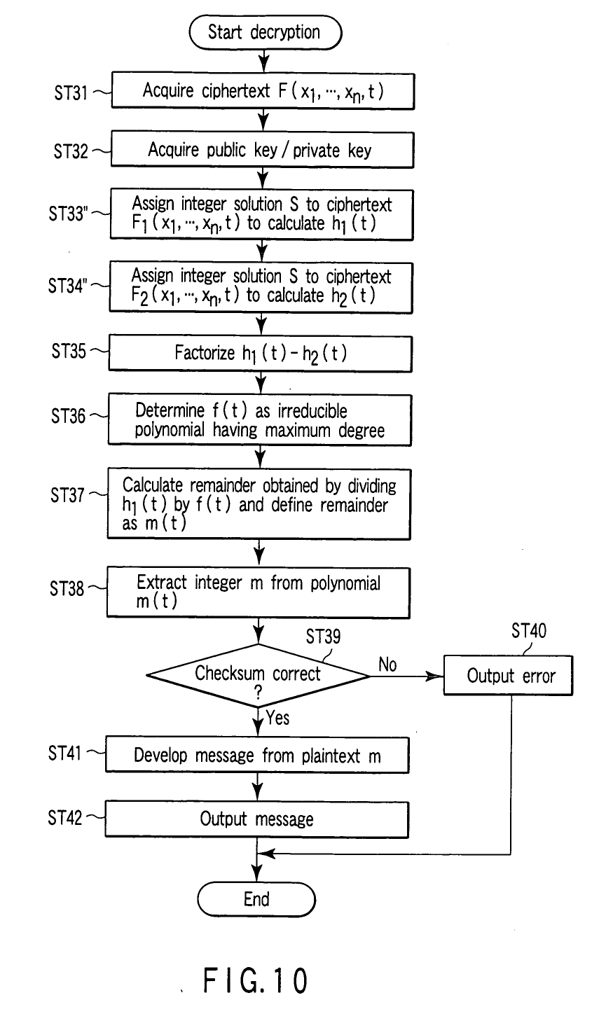

Finally, the configuration of the decryption apparatus according to the embodiment and a flow of processes in the decryption apparatus will be described below with reference to an entire block diagram shown in FIG. 5 along a flow chart shown in FIG. 10. A decryption apparatus 30 according to the embodiment starts the processes by acquiring ciphertexts F₁(x,y,t) and F₂(x,y,t) from a ciphertext input unit 31 (ST31) and acquiring a public key X(x,y) and a private key S from the public-key input unit 22 (ST32). In this case, the private key is one integer solution. The integer solution S defined by the equation (11) described in the key generating is used as the private key. The acquired ciphertexts and the acquired key information are transmitted to the decrypting unit 33 to start the decrypting process.

A decrypting unit 33 transmits the ciphertext F₁(x,y,t) and the integer solution S to the integer solution assigning unit 34. The integer solution assigning unit 34 assigns the integer solution S to the ciphertext F₁(x,y,t), and obtains the following polynomial h₁(t) by using a polynomial operating unit 35 as needed (ST33″).

$$\begin{matrix}{h}_{1} ( t ) = {F}_{1} \\ = ( {c}_{1} , {c}_{2} , t ) \\ = 800741264196844825514208199714151644148995953 \\ 6360140 t + 10268801300282823269490657123876118 \\ 4606687954064803 {t}^{2} + 4286998400844807491216387 \\ 583294262117291688667516 {t}^{3} + 410407842079321 \\ 04092127971459446848843903136983750750 {t}^{4} + \\ 426588477720170920565303449551688480604201190 \\ 3570934409 {t}^{5} + 426686091399728285412438195418 \\ 95345512082637443267171 {t}^{6} + 973075327537098988 \\ 8565027755478910931997570904 {t}^{7} + 749466952598 \\ 3300917913021929887829291576 {t}^{8} + 174334797103 \\ 5537679902679020393293226520629\end{matrix}$$

In this case, the polynomial operating unit 35 performs addition, subtraction, multiplication, and division of the polynomial. Similarly, an integer solution assigning unit 34 assigns the integer solution S₂ to F₂(x,y,t) to obtain the following polynomial h₂(t) (ST34″).
h₂(t)=F₂=(c₁,c₂,t)=664550230823316653390979041888403701t+12736065594945568170868067764966935379923873572371t²+163325917061633344883045333054398027936845906112t³+37128996092509000885925068894943175926549656021t⁴+65277168011322969793383194351134288752115929968844t⁵+6785036663271155725699621137449002104068558986856199t⁶+68019696661992480957204158866754141535243938130120t⁷+16147637558487126419253334341838078084051926754840t⁸+708513246126888584558173187869682+161509643272755098089927171571346435448258151616t⁹

The obtained assignment results h₁(t) and h₂(t) are transmitted from the integer solution assigning unit 34 to the decrypting unit 33.

The decrypting unit 33 transmits the assignment results h₁(t) and h₂(t) to the polynomial operating unit 35 to cause the polynomial operating unit 35 to subtracts the assignment results h₁(t) and h₂(t). The subtraction result is transmitted to the factorizing unit 36 to factorize the result (ST35), thereby obtained a factorization result as shown in the equation (12). At this time, the factorization result is stored in the memory.

$$\begin{matrix}{h}_{1} ( t ) - {h}_{2} ( t ) = 80074126419684475905918511738248630 \\ 50510917647956439 t + 899519474078826 \\ 64524038503473794249226764080492432 \\ {t}^{2} + 412367248378317414633334225023986 \\ 4089354842761404 {t}^{3} + 41040747078936011 \\ 583127085534377953900727210434094729 \\ {t}^{4} + 426581950003369788268324111232253 \\ 3671753259787640965565 {t}^{5} + 358835724767 \\ 01672815544198404446343408014078456410 \\ 972 {t}^{6} - 6800996590871710996731559383899 \\ 8662624311940559216 {t}^{7} - 161476375509924 \\ 56893270033423925056154164097463264 \\ {t}^{8} + 174334797032702443377579043583512 \\ 003865094716150964327275509808992717157 \\ 1346435448258151616 {t}^{9} \\ = - ( 17133746509475672633 + 21972129779797 \\ 7219 t + 9172974197261927 {t}^{2} + 87816428187 \\ 483217681 {t}^{3} + 9127865831194057238632 {t}^{4} + \\ 91297463724832569832 {t}^{5} ) ( 17690485220875 \\ 31738617095288 {t}^{4} - 8209066517523398343 \\ 6 {t}^{3} + 743225631547017578695621521895 \\ {t}^{2} - 467347444268400941876582610064246 \\ t - 101749373341252637383259 )\end{matrix} \qquad ( 12 )$$

The decrypting unit 33 uses a factor extracting unit 37 to determine an irreducible polynomial f(t) as an irreducible polynomial having the maximum degree from the factorization result in the memory (ST36).

The decrypting unit 33 transmits the irreducible polynomial f(t) and the assignment result h₁(t) to a remainder operating unit 38. The remainder operating unit 38 divides the assignment result h₁(t) by the irreducible polynomial f(t), calculates the polynomial m(t) as a remainder (ST37), and transmits the plaintext m to the decrypting unit 33 (ST38).

In the decrypting unit 33, as in the above description, the polynomial m is transmitted to the plaintext developing unit 39, the plaintext m is extracted from the polynomial m(t), and the plaintext m is developed into a message (ST38 to ST41). The message is output from a plaintext output unit 40 (ST42) to end the decrypting process.

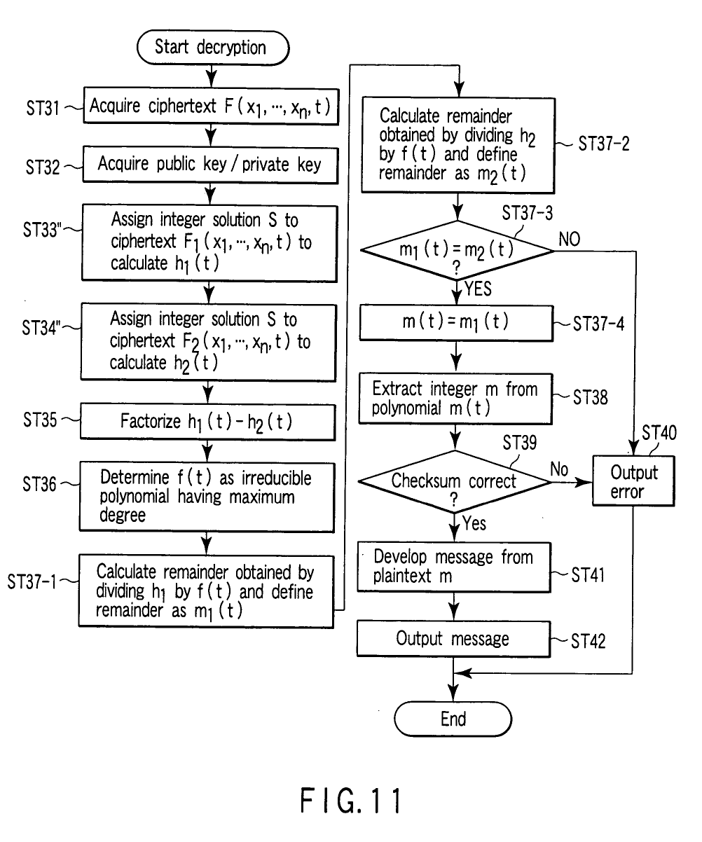

Even in the embodiment, the first to fourth variations can be executed by the same realizing method as in the first embodiment. An algorithm related to the third variation is shown in FIG. 11.

This is the end of explanation of the concrete configurations of the key generation apparatus, the encryption apparatus, and the decryption apparatus according to the second embodiment of the present invention.

As described above, according to the embodiment, unlike in the first embodiment, one integer solution S is used as a private key. However, as in the first embodiment, the encryption apparatus 20, the decryption apparatus 30, or the key generation apparatus 10 of a public-key encryption method which uses a problem that calculates an integer solution of a diophantine equation as the basis of security are realized. For this reason, as in the first embodiment, a public-key encryption method which can assure the security even though a quantum computer appears, which can be securely realized by an existing computer, and which may be realized in a low-electric-power environment can be constituted.

According to the second embodiment, unlike in the first embodiment, since a configuration may be made such that one integer solution S is satisfied, a key having a degree of freedom higher than that in the first embodiment can be generated easily more than the key in the first embodiment.

The techniques described in the embodiments can be partly stored, as programs that can be executed by a computer, in storage media such as a magnetic disk (floppy (registered trade mark) disk, hard disk, or the like), an optical disk (CD-ROM, DVD, or the like), a magneto-optic disk (MO), or a semiconductor memory, and the like, and can be distributed.

The storage media may be in any form provided that it can store programs and can be read by the computer.

An operating system (OS) or middleware such as database management software or network software may execute part of the processes required to implement the present embodiment; the OS operates on the computer on the basis of instructions from a program installed in the computer.

The storage media according to the present invention is not limited to media independent of the computer but includes storage media in which programs transmitted over the Internet or the like are permanently or temporarily stored by downloading.

The number of storage media is not limited to one. The storage media according to the present invention includes the execution of the process according to the present embodiment from a plurality of media. The media may be arbitrarily configured.

The computer according to the present invention executes the processes according to the present embodiment on the basis of the programs stored in the storage media. The computer may be arbitrarily configured; it may consist of one apparatus similarly to a personal computer or may be a system in which a plurality of apparatuses are connected together via a network.

The computer according to the present invention is not limited to a personal computer but includes an arithmetic processing apparatus, a microcomputer, or the like contained in information processing equipment. The computer is a general term for equipment and apparatuses that can realize the functions of the present invention using programs.

The present invention is not limited to the as-described embodiments. In implementation, the present invention can be embodied by varying the components of the embodiments without departing from the spirit of the present invention. Further, various inventions can be formed by appropriately combining a plurality of the components disclosed in the embodiments. For example, some of the components shown in the embodiments may be omitted. Moreover, components of different embodiments may be appropriately combined together.

What is claimed is:

1. An encryption apparatus to encrypt a message on the basis of a diophantine equation X(x₁, . . . , xₙ) serving as a public key and a minimum degree L of an irreducible polynomial when a private key for decryption is two integer solutions corresponding to a diophantine equation X(x₁, . . . , xₙ)=0, the encryption apparatus comprising:
a developing device configured to develop the message into an integer m;
an embedding device configured to embed the integer m in a polynomial m(t) having a degree not more than a degree (L−1);
a polynomial generating device configured to generate two random polynomials p(x₁, . . . , xₙ, t) and q(x₁, . . . , xₙ, t);
an irreducible polynomial generating device configured to generate a random irreducible polynomial f(t) having a degree not less than a degree L; and
an arithmetic operation performing device configured to perform an arithmetic operation including at least one of addition, subtraction, and multiplication of the polynomials p(x₁, . . . , xₙ, t) and q(x₁, . . . , xₙ, t), the irreducible polynomial f(t), and the diophantine equation X(x₁, . . . , xₙ) serving as a public key to the polynomial m(t) to generate a ciphertext F=Eₚₖ(m,p,q,f,X) from the polynomial m(t).

2. The encryption apparatus according to claim 1, wherein the embedding device is configured to partially embed the integer m in the polynomial m(t) and some coefficients of candidates of the irreducible polynomial f(t); and the irreducible polynomial generating device is configured to generate the irreducible polynomial f(t) by setting random values as coefficients, in which the integer m is not embedded, of the coefficients of the candidates of the irreducible polynomial f(t).

3. An encryption apparatus to encrypt a message on the basis of a diophantine equation X(x₁, . . . , xₙ) serving as a public key and a minimum degree L of an irreducible polynomial when a private key for decryption is one integer solution corresponding to a diophantine equation X(x₁, . . . , xₙ)=0, the encryption apparatus comprising:
a developing device configured to develop the message into an integer m;
an embedding device configured to embed the integer m in a polynomial m(t) having a degree not more than a degree (L−1);
a polynomial generating device configured to generate two random combinations of polynomials p₁(x₁, . . . , xₙ, t), p₂(x₁, . . . , xₙ, t), q₁(x₁, . . . , xₙ, t), and q₂(x₁, . . . , xₙ, t) at least one of which is different from the other polynomial;
an irreducible polynomial generating device configured to generate a random irreducible polynomial having a degree not less than a degree L; and
an arithmetic operation performing device configured to perform an arithmetic operation including at least one of addition, subtraction, and multiplication of the polynomials p₁(x₁, . . . , xₙ, t), p₂(x₁, . . . , xₙ, t), q₁(x₁, . . . , xₙ, t), and q₂(x₁, . . . , xₙ, t), the irreducible polynomial f(t), and the diophantine equation X(x₁, . . . , xₙ) serving as a public key to the polynomial m(t) to generate ciphertexts F₁=Eₚₖ(m,p₁,q₁,f,X) and F₂=Eₚₖ(m,p₂,q₂,f,x) from the polynomial m(t).

4. The encryption apparatus according to claim 3, wherein the embedding device is configured to partially embed the integer m in the polynomial m(t) and some coefficients of candidates of the irreducible polynomial f(t); and the irreducible polynomial generating device is configured to generate the irreducible polynomial f(t) by setting random values as coefficients, in which the integer m is not embedded, of the coefficients of the candidates of the irreducible polynomial f(t).

5. A decryption apparatus to decrypt a message from a ciphertext F=Eₚₖ(m,p,q,f,X) on the basis of two integer solutions S₁ and S₂ corresponding to a diophantine equation X(X₁, . . . , xₙ)=0 and serving as private keys for decryption stored in advance when the ciphertext F=Eₚₖ(m,p,q,f,X) is input, the ciphertext F=Eₚₖ(m,p,q,f,X) being generated from a polynomial m(t) having a degree not more than a degree (L−1) and obtained by embedding a message such that an arithmetic operation including at least one of addition, subtraction, and multiplication of two random polynomials p(x₁, . . . , xₙ, t) and q(x₁, . . . , xₙ, t), an irreducible polynomial f(t), and a diophantine equation X(x₁, . . . , xₙ) serving as a public key is performed to the polynomial m(t), the decryption apparatus comprising:
an integer solution assigning device configured to separately assign the integer solutions S₁ and S₂ to the input ciphertext F to generate two polynomials h₁(t) and h₂(t);
a polynomial subtracting device configured to subtract the other polynomial h₂(t) from one polynomial h₁(t) obtained by the assignment to obtain a subtraction result (h₁(t)−h₂(t));
a factorizing device configured to factorize the subtraction result (h₁(t)−h₂(t));
an irreducible polynomial extracting device configured to extract an irreducible polynomial f(t) having the maximum degree from the factorization result; and
a dividing device configured to divide the polynomial h₁(t) or h₂(t) obtained by the assignment by the irreducible polynomial f(t) to acquire a remainder equivalent to the polynomial m(t) corresponding to the message.

6. The decryption apparatus according to claim 5, wherein the ciphertext F=Eₚₖ(m,p,q,f,x) is generated from the polynomial m(t) and the irreducible polynomial f(t), the polynomials m(t) and f(t) are obtained by embedding the message.

7. A decryption apparatus to decrypt a message from ciphertexts F₁=Eₚₖ(m,p₁,q₁,f,X) and F₂=Eₚₖ(m,p₂,q₂,f,X) on the basis of one integer solution S corresponding to a diophantine equation X(X₁, . . . , xₙ)=0 and serving as a private key for decryption stored in advance when the ciphertexts F₁=Eₚₖ(m,p₁,q₁,f,X) and F₂=Eₚₖ(m,p₂,q₂,f,X) are input, the ciphertexts F₁=Eₚₖ(m,p₁,q₁,f,X) and F₂=Eₚₖ(m,p₂,q₂,f,X) being generated from a polynomial m(t) having a degree not more than a degree (L−1) and obtained by embedding a message such that an arithmetic operation including at least one of addition, subtraction, and multiplication of two random combinations of polynomials p₁(x₁, . . . , xₙ, t), p₂(x₁, . . . , xₙ, t), q₁(x₁, . . . , xₙ, t), and q₂(x₁, . . . , xₙ, t) at least one of which is different from the other polynomial, an irreducible polynomial f(t), and a diophantine equation X(x₁, . . . , xₙ) serving as a public key is performed to the polynomial m(t), the decryption apparatus comprising:
an integer solution assigning device configured to separately assign the integer solution S to the input ciphertexts F₁ and F₂ to generate two polynomials h₁(t) and h₂(t);
a polynomial subtracting device configured to subtract the other polynomial h₂(t) from one polynomial h₁(t) obtained by the assignment to obtain a subtraction result (h₁(t)−h₂(t));
a factorizing device configured to factorize the subtraction result (h₁(t)−h₂(t));
an irreducible polynomial extracting device configured to extract an irreducible polynomial f(t) having the maximum degree from the factorization result; and
a dividing device configured to divide the polynomial h₁(t) or h₂(t) obtained by the assignment by the irreducible polynomial f(t) to acquire a remainder equivalent to the polynomial m(t) corresponding to the message.

8. The decryption apparatus according to claim 7, wherein the ciphertexts F₁=Eₚₖ(m,p₁,q₁,f,X) and F₂=Eₚₖ(m,p₂, q₂,f,X) are generated from the polynomial m(t) and the irreducible polynomial f(t), the polynomials m(t) and f(t) are obtained by embedding the message.

9. A key generation apparatus to generate a diophantine equation X(X₁, . . . , xₙ) serving as a public key to decrypt a polynomial m(t) having a degree not more than a degree (L−1) and obtained by embedding a message and two integer solutions S₁ and S₂ corresponding to the diophantine equation X(X₁, . . . , xₙ)=0 and serving as a private key to decrypt the decrypted polynomial m(t), the key generation apparatus comprising:
a diophantine equation determining device configured to determine a diophantine equation having a form in which a plurality of coefficients are set as variables;
an integer solution generating device configured to generate two integer solutions S₁=(c₁, . . . , cₙ) and S₂=(g₁, . . . , gₙ) at random;
a matrix expressing device configured to express, as a matrix, simultaneous equations obtained by assigning the two integer solutions S₁ and S₂ to the diophantine equation having the form to generate a coefficient matrix of the simultaneous equations;
a flushing method performing device configured to perform a flushing method to the coefficient matrix to arithmetically operate an elementary solution where some coefficients of the coefficients are expressed by other coefficients which are free variables;
a random value assigning device configured to assign random values to the free variables of the elementary solution to generate a first coefficient vector where coefficients are expressed by integer elements and/or rational elements;
a multiplying device configured to multiply the elements of the first coefficient vectors by the least common multiple of the denominators of the elements to generate a second coefficient vector where the coefficients are expressed by integer elements; and
a diophantine equation generating device configured to generate the diophantine equation X on the basis of the second coefficient vector and the diophantine equation having the form.

10. A key generation apparatus to generate a diophantine equation X(X₁, . . . , xₙ) serving as a public key to decrypt a polynomial m(t) having a degree not more than a degree (L−1) and obtained by embedding a message and an integer solution S corresponding to the diophantine equation X(X₁, . . . , xₙ)=0 and serving as a private key to decrypt the decrypted polynomial m(t), the key generation apparatus comprising:
a diophantine equation determining device configured to determine a diophantine equation having a form consisting of a variable term having coefficients as variables and a constant term;
an integer solution generating device configured to generate an integer solution S at random;
a coefficient determining device configured to determine the coefficients of the variable term in the diophantine equation having the form at random; and
a constant term calculating device configured to calculate the constant term of the diophantine equation having the form from the generated integer solution S and the determined coefficient to generate the diophantine equation X.

11. A program stored in a computer readable storage media used in a computer for an encryption apparatus to encrypt a message on the basis of a diophantine equation X(x₁, . . . , xₙ) serving as a public key and a minimum degree L of an irreducible polynomial when a private key for decryption is two integer solutions corresponding to a diophantine equation X(x₁, . . . , xₙ)=0, the program comprising:
first program code which causes the computer to execute a process of developing the message into an integer m;
second program code which causes the computer to execute a process of embedding the integer m in a polynomial m(t) having a degree not more than a degree (L−1);
third program code which causes the computer to execute a process of generating two random polynomials p(x₁, . . . , xₙ, t) and q(x₁, . . . , xₙ, t);
fourth program code which causes the computer to execute a process of generating a random irreducible polynomial f′(t) having a degree not less than a degree L and storing the irreducible polynomial f′(t) in a memory, and irreducibly determining an irreducible polynomial candidate f′(t) in the memory to generate an irreducible polynomial f(t); and
fifth program code which causes the computer to execute a process of performing an arithmetic operation including at least one of addition, subtraction, and multiplication of the polynomials p(x₁, . . . , xₙ, t) and q(x₁, . . . , xₙ, t), the irreducible polynomial f(t), and the diophantine equation X(x₁, . . . , xₙ) serving as a public key to the polynomial m(t) to generate a ciphertext F=Eₚₖ(m,p,q,f,X) from the polynomial m(t).

12. The program according to claim 11, wherein the second program code is code which causes the computer to execute a process of partially embedding the integer m in the polynomial m(t) and some coefficients of candidates of the irreducible polynomial f(t); and the fourth program code is code which causes the computer to execute the process of generating the irreducible polynomial f′(t) by setting random values as coefficients, in which the message is not embedded, of the coefficients of the candidates of the irreducible polynomial f′(t) having the degree not less than the degree L, storing the irreducible polynomial f′(t) in a memory, and irreducibly determining an irreducible polynomial candidate f′(t) in the memory to generate the irreducible polynomial f(t).

13. A program stored in a computer readable storage media used in a computer for an encryption apparatus to encrypt a message on the basis of a diophantine equation X(x₁, . . . , xₙ) serving as a public key and a minimum degree L of an irreducible polynomial when a private key for decryption is one integer solution corresponding to a diophantine equation X(x₁, . . . , xₙ)=0, the program comprising:
first program code which causes the computer to execute a process of developing the message into an integer m;
second program code which causes the computer to execute a process of embedding the integer m in a polynomial m(t) having a degree not more than a degree (L−1);
third program code which causes the computer to execute a process of generating two random combinations of polynomials p₁(x₁, . . . , xₙ, t), p₂(x₁, . . . , xₙ, t), q₁(x₁, . . . , xₙ, t), and q₂(x₁, . . . , xₙ, t) at least one of which is different from the other polynomial;
fourth program code which causes the computer to execute a process of generating a random irreducible polynomial f′(t) having the degree not less than the degree L, storing the irreducible polynomial f′(t) in a memory, and irreducibly determining an irreducible polynomial candidate f′(t) in the memory to generate an irreducible polynomial f(t); and
fifth program code which causes the computer to execute a process of performing an arithmetic operation including at least one of addition, subtraction, and multiplication of the polynomials p₁(x₁, . . . , xₙ, t), p₂(x₁, . . . , xₙ, t), q₁(x₁, . . . , xₙ, t), and q₂(x₁, . . . , xₙ, t), the irreducible polynomial f(t), and the diophantine equation X(x₁, . . . , xₙ) serving as a public key to the polynomial m(t) to generate ciphertexts F₁=Eₚₖ(m,p₁,q₁,f,X) and F₂=Eₚₖ(m,p₂,q₂,f,X) from the polynomial m(t).

14. A program according to claim 13, wherein the second program code is code which causes the computer to execute a process of partially embedding the integer m in the polynomial m(t) and some coefficients of candidates of the irreducible polynomial f(t); and the fourth program code is code which causes the computer to execute the process of generating the irreducible polynomial f′(t) by setting random values as coefficients, in which the message is not embedded, of the coefficients of the candidates of the irreducible polynomial f′(t).

15. A program stored in a computer readable storage media used in a computer for a decryption apparatus to decrypt a message from a ciphertext F=Eₚₖ(m,p,q,f,X) on the basis of two integer solutions S₁ and S₂ corresponding to a diophantine equation X(X₁, . . . , xₙ)=0 and serving as private keys for decryption stored in advance when the ciphertext F=Eₚₖ(m,p,q,f,X) is input, the ciphertext F=Eₚₖ(m,p,q,f,X) being generated from a polynomial m(t) having a degree not more than a degree (L−1) and obtained by embedding a message such that an arithmetic operation including at least one of addition, subtraction, and multiplication of two random polynomials p(x₁, . . . , xₙ, t) and q(x₁, . . . , xₙ, t), and a diophantine equation X(x₁, . . . , xₙ) serving as a public key is performed to the polynomial m(t), the program comprising:
first program code which causes the computer to execute a process of separately assigning the integer solutions S₁ and S₂ to the input ciphertext F to generate two polynomials h₁(t) and h₂(t);
second program code which causes the computer to execute a process of subtracting the other polynomial h₂(t) from one polynomial h₁(t) obtained by the assignment to obtain a subtraction result (h₁(t)−h₂(t));
third program code which causes the computer to execute a process of factorizing the subtraction result (h₁(t)−h₂(t)) and store the obtained factorization result in a memory;
fourth program code which causes the computer to execute a process of extracting an irreducible polynomial f(t) having the maximum degree from the factorization result; and
fifth program code which causes the computer to execute a process of dividing the polynomial h₁(t) or h₂(t) obtained by the assignment by the irreducible polynomial f(t) to acquire a remainder equivalent to the polynomial m(t) corresponding to the message.

16. The program according to claim 15, wherein the ciphertext F=Eₚₖ(m,p,q,f,X) is generated from the polynomial m(t) and the irreducible polynomial f(t), the polynomials m(t) and f(t) are obtained by embedding the message.

17. A program stored in a computer readable storage media used in a computer for a decryption apparatus to decrypt a message from ciphertexts F₁=Eₚₖ(m,p₁,q₁,f,X) and F₂=Eₚₖ(m,p₂,q₂,f,X) on the basis of one integer solution S corresponding to a diophantine equation X(X₁, . . . , xₙ)=0 and serving as a private key for decryption stored in advance when the ciphertexts F₁=Eₚₖ(m,p₁,q₁,f,X) and F₂=Eₚₖ(m,p₂,q₂,f,X) are input, the ciphertexts F₁=Eₚₖ(m,p₁,q₁,f,X) and F₂=Eₚₖ(m,p₂,q₂,f,X) being generated from a polynomial m(t) having a degree not more than a degree (L−1) and obtained by embedding a message such that an arithmetic operation including at least one of addition, subtraction, and multiplication of two random combinations of polynomials p₁(x₁, . . . , xₙ, t), p₂(x₁, . . . , xₙ, t), q₁(x₁, . . . , xₙ, t), and q₂(x₁, . . . , xₙ, t) at least one of which is different from the other polynomial, an irreducible polynomial f(t), and a diophantine equation X(x₁, . . . , xₙ) serving as a public key is performed to the polynomial m(t), the program comprising:
first program code which causes the computer to execute a process of separately assigning the integer solution S to the input ciphertexts F₁ and F₂ to generate two polynomials h₁(t) and h₂(t);
second program code which causes the computer to execute a process of subtracting the other polynomial h₂(t) from one polynomial h₁(t) obtained by the assignment to obtain a subtraction result (h₁(t)−h₂(t));
third program code which causes the computer to execute a process of factorizing the subtraction result (h₁(t)−h₂(t)) and storing the obtained factorization result in a memory;
fourth program code which causes the computer to execute a process of extracting an irreducible polynomial f(t) having the maximum degree from the factorization result in the memory; and
fifth program code which causes the computer to execute a process of dividing the polynomial h₁(t) or h₂(t) obtained by the assignment by the irreducible polynomial f(t) to acquire a remainder equivalent to the polynomial m(t) corresponding to the message.

18. The program according to claim 17, wherein the ciphertexts F₁=Eₚₖ(m,p₁,q₁,f,X) and F₂=Eₚₖ(m,p₂,q₂,f,X) are generated from the polynomial m(t) and the irreducible polynomial f(t), the polynomials m(t) and f(t) are obtained by embedding the message.

19. A program stored in a computer readable storage media used in a computer for a key generation apparatus to generate a diophantine equation X(X₁, . . . , xₙ) serving as a public key to decrypt a polynomial m(t) having a degree not more than a degree (L−1) and obtained by embedding a message and two integer solutions S₁ and S₂ corresponding to the diophantine equation X(X₁, . . . , xₙ)=0 and serving as a private key to decrypt the decrypted polynomial m(t), the program comprising:
first program code which causes the computer to execute a process of determining a diophantine equation having a form in which a plurality of coefficients are set as variables;
second program code which causes the computer to execute a process of generating two integer solutions S₁=(c₁, . . . , cₙ) and S₂=(g₁, . . . , gₙ) at random;
third program code which causes the computer to execute a process of expressing, as a matrix, simultaneous equations obtained by assigning the two integer solutions S₁ and S₂ to the diophantine equation having the form to generate a coefficient matrix of the simultaneous equations;
fourth program code which causes the computer to execute a process of performing a flushing method to the coefficient matrix to arithmetically operate an elementary solution where some coefficients of the coefficients are expressed by other coefficients which are free variables;
fifth program code which causes the computer to execute a process of assign random values to the free variables of the elementary solution to generate a first coefficient vector where coefficients are expressed by integer elements and/or rational elements;
sixth program code which causes the computer to execute a process of multiplying the elements of the first coefficient vectors by the least common multiple of the denominators of the elements to generate a second coefficient vector where the coefficients are expressed by integer elements; and
seventh program code which causes the computer to execute a process of generating the diophantine equation X on the basis of the second coefficient vector and the diophantine equation having the form.

20. A program stored in a computer readable storage media used in a computer for a key generation apparatus to generate a diophantine equation X(X₁, . . . , xₙ) serving as a public key to decrypt a polynomial m(t) having a degree not more than a degree (L−1) and obtained by embedding a message and an integer solution S corresponding to the diophantine equation X(X₁, . . . , xₙ)=0 and serving as a private key to decrypt the decrypted polynomial m(t), the program comprising:
first program code which causes the computer to execute a process of determining a diophantine equation having a form consisting of a variable term having coefficients as variables and a constant term;
second program code which causes the computer to execute a process of generating an integer solution S at random;
third program code which causes the computer to execute a process of determining the coefficients of the variable term in the diophantine equation having the form at random; and
fourth program code which causes the computer to execute a process of calculating the constant term of the diophantine equation having the form from the generated integer solution S and the determined coefficient to generate the diophantine equation X.

21. An encryption method executed by an encryption apparatus to encrypt a message on the basis of a diophantine equation X(x₁, . . . , xₙ) serving as a public key and a minimum degree L of an irreducible polynomial when a private key for decryption is two integer solutions corresponding to a diophantine equation X(x₁, . . . , xₙ)=0, the encryption method comprising:
developing the message into an integer m;
embedding the integer m in a polynomial m(t) having a degree not more than a degree (L−1);
generating two random polynomials p(x₁, . . . , xₙ, t) and q(x₁, . . . , xₙ, t);
generating a random polynomial f(t) having a degree not less than a degree L; and
performing an arithmetic operation including at least one of addition, subtraction, and multiplication of the polynomials p(x₁, . . . , xₙ, t) and q(x₁, . . . , xₙ, t), the irreducible polynomial f(t), and the diophantine equation X(x₁, . . . , xₙ) serving as a public key to the polynomial m(t) to generate a ciphertext F=Eₚₖ(m,p,q,f,X) from the polynomial m(t).

22. The encryption method according to claim 21, wherein embedding the integer m includes
partially embedding the integer m in the polynomial m(t) and some coefficients of candidates of the irreducible polynomial f(t); and
wherein generating the irreducible polynomial f(t) includes
generating the irreducible polynomial f(t) by setting random values as coefficients, in which the integer m is not embedded, of the coefficients of the candidates of the irreducible polynomial f(t).

23. An encryption method executed by an encryption apparatus to encrypt a message on the basis of a diophantine equation X(x₁, . . . , xₙ) serving as a public key and a minimum degree L of an irreducible polynomial when a private key for decryption is one integer solution corresponding to a diophantine equation X(x₁, . . . , xₙ)=0, the encryption method comprising:
developing the message into an integer m;
embedding the integer m in a polynomial m(t) having a degree not more than a degree (L−1);
generating two random combinations of polynomials p₁(x₁, . . . , xₙ, t), p₂(x₁, . . . , xₙ, t), q₁(x₁, . . . , xₙ, t), and q₂(x₁, . . . , xₙ, t) at least one of which is different from the other polynomial;
generating a random irreducible polynomial f(t) having a degree not less than a degree L; and
performing an arithmetic operation including at least one of addition, subtraction, and multiplication of the polynomials p₁(x₁, . . . , xₙ, t), p₂(x₁, . . . , xₙ, t), q₁(x₁, . . . , xₙ, t), and q₂(x₁, . . . , xₙ, t), the irreducible polynomial f(t), and the diophantine equation X(x₁, . . . , xₙ) serving as a public key to the polynomial m(t) to generate ciphertexts F₁=Eₚₖ(m,p₁,q₁,f,X) and F₂=Eₚₖ(m,p₂,q₂,f,X) from the polynomial m(t).

24. The encryption method according to claim 23, wherein embedding the integer m includes
partially embedding the integer m in the polynomial m(t) and some coefficients of candidates of the irreducible polynomial f(t); and
wherein generating the irreducible polynomial f(t) includes
generating the irreducible polynomial f(t) by setting random values as coefficients, in which the integer m is not embedded, of the coefficients of the candidates of the irreducible polynomial f(t).

25. A decryption method executed by a decryption apparatus to decrypt a message from a ciphertext F=Eₚₖ(m,p,q,f,X) on the basis of two integer solutions S₁ and S₂ corresponding to a diophantine equation X(X₁, . . . , xₙ)=0 and serving as private keys for decryption stored in advance when the ciphertext F=Eₚₖ(m,p,q,f,X) is input, the ciphertext F=Eₚₖ(m,p,q,f,X) being generated from a polynomial m(t) having a degree not more than a degree (L−1) and obtained by embedding a message such that an arithmetic operation including at least one of addition, subtraction, and multiplication of two random polynomials p(x₁, . . . , xₙ, t) and q(x₁, . . . , xₙ, t), an irreducible polynomial f(t), and a diophantine equation X(x₁, . . . , xₙ) serving as a public key is performed to the polynomial m(t), the decryption method comprising:
separately assigning the integer solutions S₁ and S₂ to the input ciphertext F to generate two polynomials h₁(t) and h₂(t);
subtracting the other polynomial h₂(t) from one polynomial h₁(t) obtained by the assignment to obtain a subtraction result (h₁(t)−h₂(t));
factorizing the subtraction result (h₁(t)−h₂(t));
extracting an irreducible polynomial f(t) having the maximum degree from the factorization result; and
dividing the polynomial h₁(t) or h₂(t) obtained by the assignment by the irreducible polynomial f(t) to acquire a remainder equivalent to the polynomial m(t) corresponding to the message.

26. The decryption method according to claim 25, wherein the ciphertext F=Eₚₖ(m,p,q,f,X) is generated from the polynomial m(t) and the irreducible polynomial f(t), the polynomials m(t) and f(t) are obtained by embedding the message.

27. A decryption method executed by a decryption apparatus to decrypt a message from ciphertexts F₁=Eₚₖ(m,p₁,q₁,f,X) and F₂=Eₚₖ(m,p₂,q₂,f,X) on the basis of one integer solution S corresponding to a diophantine equation X(X₁, . . . , xₙ)=0 and serving as a private key for decryption stored in advance when the ciphertexts F₁=Eₚₖ(m,p₁,q₁,f,X) and F₂=Eₚₖ(m,p₂,q₂,f,x) are input, the ciphertexts F₁=Eₚₖ(m,p₁,q₁,f,X) and F₂=Eₚₖ(m,p₂,q₂,f,X) being generated from a polynomial m(t) having a degree not more than a degree (L−1) and obtained by embedding a message such that an arithmetic operation including at least one of addition, subtraction, and multiplication of two random combinations of polynomials p₁(x₁, xₙ, t), p₂(x₁, . . . , xₙ, t), q₁(x₁, . . . , xₙ, t), and q₂(x₁, . . . , xₙ, t) at least one of which is different from the other polynomial, an irreducible polynomial f(t) having a degree not less than a degree L, and a diophantine equation X(x₁, . . . , xₙ) serving as a public key is performed to the polynomial m(t), the decryption method comprising:
separately assigning the integer solution S to the input ciphertexts F₁ and F₂ to generate two polynomials h₁(t) and h₂(t);
subtracting the other polynomial h₂(t) from one polynomial h₁(t) obtained by the assignment to obtain a subtraction result (h₁(t)−h₂(t));
factorizing the subtraction result (h₁(t)−h₂(t));
extracting an irreducible polynomial f(t) having the maximum degree from the factorization result; and
dividing the polynomial h₁(t) or h₂(t) obtained by the assignment by the irreducible polynomial f(t) to acquire a remainder equivalent to the polynomial m(t) corresponding to the message.

28. The decryption method according to claim 27, wherein the ciphertexts F₁=Eₚₖ(m,p₁,q₁,f,X) and F₂=Eₚₖ(m,p₂,q₂,f,X) are generated from the polynomial m(t) and the irreducible polynomial f(t), the polynomials m(t) and f(t) are obtained by embedding the message.

29. A key generation method executed by the key generation apparatus to generate a diophantine equation X(X₁, . . . , xₙ) serving as a public key to decrypt a polynomial m(t) having a degree not more than a degree (L−1) and obtained by embedding a message and two integer solutions S₁ and S₂ corresponding to the diophantine equation X(X₁, . . . , xₙ)=0 and serving as a private key to decrypt the decrypted polynomial m(t), the key generation method comprising:
determining a diophantine equation having a form in which a plurality of coefficients are set as variables;
generating two integer solutions S₁=(c₁, . . . , cₙ) and S₂=(g₁, . . . , gₙ) at random;
expressing, as a matrix, simultaneous equations obtained by assigning the two integer solutions S₁ and S₂ to the diophantine equation having the form to generate a coefficient matrix of the simultaneous equations;
performing a flushing method to the coefficient matrix to arithmetically operate an elementary solution where some coefficients of the coefficients are expressed by other coefficients which are free variables;
assigning random values to the free variables of the elementary solution to generate a first coefficient vector where coefficients are expressed by integer elements and/or rational elements;
multiplying the elements of the first coefficient vectors by the least common multiple of the denominators of the elements to generate a second coefficient vector where the coefficients are expressed by integer elements; and
generating the diophantine equation X on the basis of the second coefficient vector and the diophantine equation having the form.

30. A key generation method executed by the key generation apparatus to generate a diophantine equation X(X₁, . . . , xₙ) serving as a public key to decrypt a polynomial m(t) having a degree not more than a degree (L−1) and obtained by embedding a message and an integer solution S corresponding to the diophantine equation X(X₁, . . . , xₙ)=0 and serving as a private key to decrypt the decrypted polynomial m(t), the key generation method comprising:
determining a diophantine equation having a form consisting of a variable term having coefficients as variables and a constant term;
generating an integer solution S at random;
determining the coefficients of the variable term in the diophantine equation having the form at random; and
calculating the constant term of the diophantine equation having the form from the generated integer solution S and the determined coefficient to generate the diophantine equation X.
